(19) United States
(12) Patent Application Publication
(10) Pub. No.: US 2016/0274476 A1
(43) Pub. Date: Sep. 22, 2016

(54) SLURRY CLEANING APPARATUS AND CLEANING SYSTEM

(71) Applicant: Mitsubishi Chemical Corporation, Chiyoda-ku (JP)

(72) Inventor: Yuqing XU, Joetsu-shi (JP)

(73) Assignee: Mitsubishi Chemical Corporation, Chiyoda-ku (JP)

(21) Appl. No.: 15/167,000

(22) Filed: May 27, 2016

Related U.S. Application Data
(63) Continuation of application No. PCT/JP2014/081335, filed on Nov. 27, 2014.

(30) Foreign Application Priority Data
Nov. 29, 2013 (JP) 2013-247796
Dec. 3, 2013 (JP) 2013-250293
Dec. 3, 2013 (JP) 2013-250294

(51) Int. Cl. G03G 9/08; B08B 3/12; B08B 3/10; B08B 3/04

(52) U.S. Cl. CPC G03G 9/0815; B08B 3/041; B08B 3/123; B08B 3/10; B08B 3/102

(57) ABSTRACT

Provided is a slurry cleaning apparatus which can efficiently clean a slurry containing toner matrix particles or resin fine particles in a shorter time. The slurry cleaning apparatus of the present invention comprises a cleaning chamber for contacting a slurry with cleaning water, and flow rate controllers for controlling the flow rate of the slurry. The flow rate controllers are located respectively at a slurry inlet through which the slurry is fed to the cleaning chamber and at a slurry outlet through which the slurry is discharged from the cleaning chamber. The cleaning chamber has at least one filtration side having water permeability, and is constructed so that the slurry flows at a constant flow rate in a space in contact with the filtration side, wherein the cleaning water is fed to the cleaning chamber and brought into contact with the slurry flowing in the space, and then passes through the filtration side.

### FIELD OF THE INVENTION

The present invention relates to a cleaning apparatus and a cleaning system for cleaning a slurry containing toner matrix particles or resin fine particles, for example, in the production process for a toner for electrostatic image development.

### BACKGROUND ART

A toner for electrostatic image development is used in the image formation for imaging an electrostatic image in, for example, a printer, a copying machine, and a facsimile machine. For example, in the image formation by an electrophotographic method, an electrostatic latent image is first formed on a photosensitive drum. Then, the electrostatic latent image is developed using a toner, and then the developed image is transferred to, for example, transfer paper. Subsequently, the toner is fixed by heat to form an image.

Conventionally, as a method for producing a toner for electrostatic image development, a melt-kneading pulverization method has been known. In this method, a binder resin and a colorant, and, if necessary, for example, a charge control agent and a magnetic material are mixed with one another. Then, the resultant mixture is melt-kneaded by an extruder, followed by pulverization and classification. This method, however, has a limitation on the particle diameter of the toner which the method can control, and thus it has been substantially difficult to produce in high yield a toner having an average particle diameter of 10 μm or less. Therefore, this method is not satisfactory in the improvement of resolution required for the electrophotography.

For removing the disadvantage, in recent years, as a method for producing a toner which is a substitute for the melt-kneading pulverization method, a wet polymerization method has been proposed. The wet polymerization method includes, for example, an emulsion polymerization aggregation method and a suspension polymerization method. Particularly, when a toner is produced by an emulsion polymerization aggregation method, the particle diameter, particle size distribution, and shape of the toner to be obtained can be relatively easily controlled.

The applications of image forming apparatuses, such as an electrophotographic copying machine, have recently expanded. In accordance with the expansion of the applications, the toner used in the apparatuses is required to have various higher performance.

For example, as the copying or printing speed is increased, it is desired that the fixing speed of the toner is increased. When the paper feed speed is high, the temperature of the surface of the fixing roller is likely to be uneven, as compared to that in the case where the paper feed speed is low, so that image quality (particularly, fixing strength or gloss) becomes poor. As a method for improving such poor image quality, more precise control of the temperature of the surface of the fixing roller is considered. However, in this case, problems are caused in that, for example, the fixing apparatus is complicated or increased in size, or becomes poor in durability, and the cost is increased. For this reason, for obtaining excellent image quality in copying or printing at a high speed, a toner having a wider range of the fixing temperature such that no offset occurs when fixing the toner is desired.

Further, recently, there are increasing demands for reduction of the energy required for forming an image, and hence the fixing step that consumes a large amount of energy is required to save the power. For meeting such demands for power-saving fixing step, it is desired that the fixing temperature of the toner is further reduced. For further reducing the fixing temperature of the toner, it is necessary to lower the glass transition temperature of the toner. However, when the glass transition temperature of the toner is lowered, the toner becomes poor in storage stability. Therefore, it has been difficult to achieve both the low-temperature fixing properties of the toner and the storage stability of the toner. For solving the problem, there has conventionally been proposed a toner which has core particles comprising a resin having excellent low-temperature fixing properties, and having the surface covered with a shell layer comprising a hard resin.

As a method for producing toner matrix particles having a core/shell structure, for example, a dry encapsulation method using an external additive and a wet encapsulation method have been known.

The dry encapsulation method is a method in which resin particles forming a shell layer are mechanically collided with the surface of core particles for toner to form a core/shell structure. As the core particles, there are used core particles which are formed by a dry process, such as a melt-kneading pulverization method, or core particles which are formed by a wet process and dried. However, in this method, there is a limitation on the amount of the shell particles which can be used in the encapsulation. Further, in this method, non-uniformity of the mechanical collision or heat generation due to the collision makes it difficult to form a uniform core/shell structure.

The wet encapsulation method is a method in which a dispersion of shell particles is directly added to a slurry or an emulsion dispersion containing core particles for toner. As the core particles, there are used core particles which are formed by a wet polymerization method, such as an emulsion polymerization aggregation method or a suspension polymerization method, or core particles which are formed by a dry process, such as a melt-kneading pulverization method. In the wet encapsulation method, the core particles are encapsulated by electrostatic adsorption between the particles in a fluid. Further, the capsule layer is then fixed to the surface of the core particles by a heat treatment. The wet encapsulation method can control, for example, the thickness and adhesion strength of the capsule layer, and therefore has been widely used particularly in the production of a wet polymer toner.

In the production process for toner matrix particles having a core/shell structure, shell particles are permitted to electrostatically adsorb onto the surface of core particles. For producing toner matrix particles having excellent performance, it is necessary to precisely control the charge state of the surface of the core particles and shell particles. Generally, by appropriately controlling the concentration of the electrolyte contained in the slurry containing the core particles or shell particles, the charge state can be controlled. As a method of controlling the electrolyte concentration, there are a method in which an electrolyte, such as a flocculant or a dispersant, is further added, a method in which a medium, such as water, is added to dilute the electrolyte solution, and a method in which the electrolyte concentration is reduced in the cleaning step.

When the core particles for a polymer toner are produced by a wet process, the resultant slurry contains an electrolyte derived from the additive added in a large amount in the granulation step. An electrolyte, such as a flocculant or a dispersant, is further added to the slurry. In the method of controlling the core/shell structure as mentioned above, there is a limitation on the control of the structure that can be made by the electrolyte concentration and, in some cases, an excellent core/shell structure is difficult to obtain.

There is a method in which a solvent, such as water, is added to dilute the electrolyte solution. In this method, for diluting the electrolyte solution, it is necessary to add a solvent, such as water, in a large amount, and therefore there is a danger that the production efficiency is lowered and further the production cost is increased.

On the other hand, there is a method in which, by a cleaning step for removing an electrolyte, the concentration of the electrolyte is controlled. This method is a method of removing an excess electrolyte from the slurry, and has a large range in which the concentration of the electrolyte can be controlled. For this reason, this method is considered to be the most effective method in the encapsulation control of the shell particles.

The cleaning step for removing an electrolyte is an indispensable step in the production of a toner by a wet polymerization method. The cleaning performance of the step largely affects the performance of the toner.

As a cleaning technique for the slurry containing the toner matrix particles, as described in patent documents 1 to 7, techniques, such as a belt filter, filter press, centrifugal hydroextraction, and vacuum filtration, have been known. In these techniques, for removing impurities on the surface of the toner matrix particles, the slurry is separated into solid and liquid, and then a cleaning fluid is fed to the surface of the resultant cake. For improving the cleaning efficiency, a method of redispersing the cake of the toner matrix particles in a cleaning fluid, such as water, to clean the cake is frequently employed. Thus, by repeatedly performing the filtration step and the reslurry cleaning step, the toner matrix particles can be cleaned to an intended cleaning level. Finally, the resultant cake of the toner matrix particles is redispersed in, for example, water and subjected to the subsequent shell particle encapsulation step, or the toner matrix particles are dried as such.

However, the above cleaning method has several problems to be solved. For example, when a cleaning fluid is fed to the cake of the toner matrix particles formed by separation into solid and liquid, the cleaning fluid bypasses the cake and goes along the crack surface formed in the cake, making it difficult to uniformly feed the cleaning fluid to the whole of the cake. When the cleaning fluid cannot be uniformly fed to the whole of the cake, not only be cleaning unevenness likely to be caused, but also the cleaning water in a larger amount may be required. By redispersing the cake of the toner matrix particles in the cleaning water, cleaning unevenness can be suppressed to some extent. However, water is squeezed out of the toner matrix particles and the resultant particles are in a state of cake, and therefore it is difficult to completely redisperse the toner matrix particles in water. Particularly, as cleaning of the toner matrix particles proceeds, a dispersant, such as an emulsifying agent adhering to the surface of the toner matrix particles, is reduced. As a result, it is further difficult to disperse the cake of the toner matrix particles, so that flocculate of the toner matrix particles in an undispersed state remains in a large amount in the reslurry. When the flocculate of the toner matrix particles is present, it is difficult to remove impurity components contained in the flocculate by washing, so that cleaning unevenness are likely to be caused. When encapsulation is conducted by adding shell particles to a slurry containing flocculate of the toner matrix particles, encapsulation of the toner matrix particles present inside the flocculate is difficult. In this case, uniform encapsulation of the toner matrix particles cannot be achieved, and therefore there is a danger that the toner becomes poor in performance. Further, the filtration cleaning method including reslurry cleaning is basically performed by a batch operation, and therefore it is difficult to apply this method to a continuous system.

In addition, the continuous pressure filtration apparatus described in patent document 8 has been known. There also has been known a method in which a slurry of toner matrix particles is subjected to filtration using the above apparatus without causing the toner matrix particles to be in a cake form. In this method, the slurry of the toner matrix particles is concentrated by filtration, and then cleaning water is mixed into the slurry to clean the slurry. In this method, however, when the amount of the slurry subjected to filtration is increased, the slurry is increased in the solids content and viscosity. For this reason, clogging of the filter is likely to occur, and the amount of the slurry subjected to filtration is limited, and thus this method is considered to have a low filtration efficiency.

Patent document 9 has a description about a method for producing a toner in a single reaction vessel comprising a flocculation zone, a coalescence zone, and a cleaning zone. This method comprises the steps of: subjecting a colorant and a latex emulsion to flocculation to form flocculated toner particles in the flocculation zone of the single reaction vessel; subjecting the flocculated toner particles to coalescence in the coalescence zone of the single reaction vessel to form flocculated and coalesced toner particles; and cleaning the flocculated and coalesced toner particles in the cleaning zone of the single reaction vessel to form a toner. The cleaning method described in patent document 9 has a problem in that the contact efficiency between the slurry containing the toner matrix particles and the cleaning fluid is low such that the cleaning is unsatisfactory, causing the resultant toner matrix particles to have poor quality. Further, the filtration area is extremely small due to the structure of the apparatus, and hence the cleaning efficiency is low, and therefore a problem arises in that an increased amount of time is required for the cleaning step for the slurry.

### PRIOR ART REFERENCES

### Patent Documents

Patent document 1: Japanese Unexamined Patent Publication No. 2001-281925
Patent document 2: Japanese Unexamined Patent Publication No. 2003-215841
Patent document 3: Japanese Unexamined Patent Publication No. 2002-372803
Patent document 4: Japanese Unexamined Patent Publication No. 2007-058201
Patent document 5: Japanese Unexamined Patent Publication No. 2000-292976
Patent document 6: Japanese Unexamined Patent Publication No. 2002-156788
Patent document 7: Japanese Unexamined Patent Publication No. 2001-194826
Patent document 8: Japanese Unexamined Patent Publication No. 2004-279483
Patent document 9: Japanese Unexamined Patent Publication No. 2006-350340

### SUMMARY OF THE INVENTION

### Problems to be Solved by the Invention

For improving the performance of the toner, there are increasingly strict requirements for cleaning of the toner matrix particles produced by a wet process. Further, in the case of a wet encapsulation method, for controlling the structure of the toner using a shell agent, a method is desired in which the electrolyte concentration of the slurry can be easily controlled without causing toner particle flocculate. However, the conventional cleaning methods described in patent documents 1 to 9 have poor cleaning efficiency for the toner matrix particles. In addition, it is difficult to uniformly clean the toner matrix particles by the methods. Further, the methods have a problem in that flocculate of the toner matrix particles is likely to be caused during cleaning of the toner matrix particles, making control of the concentration of the slurry difficult.

In view of the above-mentioned problems, the present invention has been made, and an object of the present invention is to provide a slurry cleaning apparatus and a slurry cleaning method, which can efficiently clean a slurry containing, for example, toner matrix particles or resin fine particles in a shorter time.

### Means for Solving the Problems

Means for solving the above-mentioned problems is the following invention.

A slurry cleaning apparatus which comprises: a cleaning chamber for contacting a slurry with cleaning water; and flow rate controllers for controlling the flow rate of the slurry,

the flow rate controllers being located respectively at a slurry inlet through which the slurry is fed to the cleaning chamber and at a slurry outlet through which the slurry is discharged from the cleaning chamber,

the cleaning chamber having at least one filtration side having water permeability, the cleaning chamber being constructed so that the slurry flows at a constant flow rate in a space in contact with the filtration side,

wherein the cleaning water is fed to the cleaning chamber and brought into contact with the slurry flowing in the space, and then passes through the filtration side.

It is preferred that the cleaning chamber has the two or more filtration sides having water permeability, wherein the cleaning water is fed to the cleaning chamber through one of the two or more filtration sides.

It is preferred that the filtration side through which the cleaning water passes when feeding the cleaning water to the cleaning chamber and the filtration side through which the cleaning water passes when filtering the slurry are switched in the course of the cleaning.

It is preferred that the slurry cleaning apparatus comprises a cleaning water feed device for feeding the cleaning water to the cleaning chamber, wherein the cleaning water is fed by the cleaning water feed device to the cleaning chamber at a constant flow rate.

It is preferred that the flow rate of the slurry and the slurry concentration in the cleaning chamber are controlled by the flow rate of the cleaning water fed by the cleaning water feed device.

It is preferred that the slurry and cleaning water are mechanically mixed with each other in the cleaning chamber.

It is preferred that the slurry cleaning apparatus comprises an ultrasonic wave generator.

It is preferred that the slurry cleaning apparatus comprises a temperature controller.

It is preferred that the slurry is a slurry containing resin fine particles.

It is preferred that the slurry is a slurry containing toner matrix particles obtained by an emulsion polymerization aggregation method.

A slurry cleaning system which comprises a plurality of the slurry cleaning apparatuses according to any one of those mentioned above.

A slurry cleaning apparatus which comprises: a cleaning chamber for contacting a slurry with cleaning water; and flow rate controllers for controlling the flow rate of the slurry,

the flow rate controllers being located respectively at a slurry inlet through which the slurry is fed to the cleaning chamber and at a slurry outlet through which the slurry is discharged from the cleaning chamber,

the cleaning chamber having at least one filtration side having water permeability, the cleaning chamber being constructed so that the slurry flows in a space in contact with the filtration side,

wherein the cleaning water is fed to the cleaning chamber and brought into contact with the slurry flowing in the space, and then passes through the filtration side,

wherein the cleaning chamber has a delivery means disposed therein for sending the slurry from the slurry inlet toward the slurry outlet.

It is preferred that the delivery means comprises a rotatable blade member disposed in the cleaning chamber.

It is preferred that the cleaning chamber is formed in a substantially cylindrical shape, wherein the slurry inlet and the slurry outlet are formed in the outer periphery of the cleaning chamber at different positions in the circumferential direction.

It is preferred that the cleaning chamber has the two or more filtration sides having water permeability, wherein the cleaning water is fed to the cleaning chamber through one of the two or more filtration sides.

It is preferred that the slurry cleaning apparatus comprises a cleaning water feed device for feeding the cleaning water to the cleaning chamber, wherein the cleaning water is fed by the cleaning water feed device to the cleaning chamber at a constant flow rate.

It is preferred that the flow rate of the slurry and the slurry concentration in the cleaning chamber are controlled by the flow rate of the cleaning water fed by the cleaning water feed device.

It is preferred that the slurry cleaning apparatus comprises an ultrasonic wave generator.

It is preferred that the slurry cleaning apparatus comprises a temperature controller.

It is preferred that the slurry is a slurry containing resin fine particles.

It is preferred that the slurry is a slurry containing toner matrix particles obtained by an emulsion polymerization aggregation method.

A stacking-type slurry cleaning apparatus which comprises a plurality of the slurry cleaning apparatuses according to any one of those mentioned above, wherein the slurry cleaning apparatuses are connected by stacking them on one another.

In the stacking-type slurry cleaning apparatus, it is preferred that the direction of flow of the cleaning water and the direction of flow of the slurry are opposite.

A slurry cleaning system which comprises a plurality of the stacking-type slurry cleaning apparatuses, wherein the stacking-type slurry cleaning apparatuses are connected in series.

A slurry cleaning apparatus which comprises: a cleaning chamber for contacting a slurry with cleaning water; and flow rate controllers for controlling the flow rate of the slurry,

the flow rate controllers being located respectively at a slurry inlet through which the slurry is fed to the cleaning chamber and at a slurry outlet through which the slurry is discharged from the cleaning chamber,

the slurry cleaning apparatus having a water supply cylinder in a substantially cylindrical shape, an inner cylinder member, and an outer cylinder member,

the inner cylinder member being disposed inside of the outer cylinder member,

the water supply cylinder being disposed inside of the inner cylinder member,

wherein the space between the water supply cylinder and the inner cylinder member constitutes the cleaning chamber,

wherein the slurry is fed to the cleaning chamber through the slurry inlet,

wherein the cleaning water is fed into the cleaning chamber through a plurality of water spray pores formed in the outer periphery of the water supply cylinder,

wherein the cleaning water fed into the cleaning chamber is brought into contact with the slurry in the cleaning chamber, and then subjected to filtration by a filtration member fitted to the inner side of the inner cylinder member,

wherein the cleaning water subjected to filtration by the filtration member is then stored in a filtrate storage chamber formed between the inner cylinder member and the outer cylinder member.

It is preferred that the filtration member is a filter cloth in a cylindrical shape.

It is preferred that a screw for transferring the slurry from the slurry inlet toward the slurry outlet is provided on the outer periphery of the water supply cylinder.

It is preferred that the slurry cleaning apparatus has a rotation driving means for rotating the water supply cylinder and the screw.

It is preferred that the slurry cleaning apparatus comprises a cleaning water feed device for feeding the cleaning water to the cleaning chamber, wherein the cleaning water is fed by the cleaning water feed device to the cleaning chamber at a constant flow rate.

It is preferred that the flow rate of the slurry and the slurry concentration in the cleaning chamber are controlled by the flow rate of the cleaning water fed by the cleaning water feed device.

It is preferred that the slurry cleaning apparatus comprises an ultrasonic wave generator.

It is preferred that the slurry cleaning apparatus comprises a temperature controller.

It is preferred that the slurry is a slurry containing resin fine particles.

It is preferred that the slurry is a slurry containing toner matrix particles obtained by an emulsion polymerization aggregation method.

A slurry cleaning system which comprises a plurality of the slurry cleaning apparatuses according to any one of those mentioned above, wherein the slurry cleaning apparatuses are connected in series.

A method for producing a toner for electrostatic image development, wherein the method has the step of cleaning a slurry using the slurry cleaning apparatus or cleaning system according to any one of those mentioned above.

A method for producing a toner for electrostatic image development, wherein the method comprises the steps of:

continuously feeding a slurry containing toner matrix particles to a cleaning apparatus;

continuously feeding cleaning water to the cleaning apparatus;

contacting the slurry with the cleaning water in the cleaning apparatus to clean the slurry;

continuously discharging the cleaned slurry from the cleaning apparatus;

subjecting to filtration the cleaning water after contacted with the slurry; and

continuously discharging the cleaning water after subjected to filtration from the cleaning apparatus,

wherein, in the cleaning apparatus, the direction of flow of the cleaning water is different from the direction of transfer of the slurry and has no countercurrent relationship with the direction of transfer of the slurry.

### Effects of the Invention

In the present invention, there can be provided a slurry cleaning apparatus which can more efficiently clean a slurry containing, for example, toner matrix particles or resin fine particles.

### BRIEF DESCRIPTION OF THE DRAWINGS

FIG. 1 A diagrammatic view showing the construction of the slurry cleaning apparatus.

FIG. 2 A cross-sectional view of the slurry cleaning apparatus.

FIG. 3 A cross-sectional view of the slurry cleaning apparatus.

FIG. 4 An exploded perspective view of the slurry cleaning apparatus.

FIG. 5 A cross-sectional view of the slurry cleaning apparatus.

FIG. 6 A cross-sectional view of the slurry cleaning apparatus.

FIG. 7 A cross-sectional view of the slurry cleaning apparatus.

FIG. 8 A cross-sectional view of the slurry cleaning apparatus.

FIG. 9 A diagrammatic view showing the construction of the slurry cleaning system.

FIG. 10 A diagrammatic view showing the construction of the slurry cleaning system.

FIG. 11 A perspective view of the slurry cleaning apparatus.

FIG. 12 A sectional side view of the slurry cleaning apparatus.

FIG. 13 A sectional top view of the slurry cleaning apparatus.

FIG. 14 A perspective view of the stacking-type slurry cleaning apparatus.

FIG. 15 A cross-sectional view of the stacking-type slurry cleaning apparatus.

FIG. 16 A diagrammatic view showing the construction of the slurry cleaning system.

FIG. 17 A diagrammatic view showing the construction of the slurry cleaning system.

FIG. 18 A cross-sectional view of the slurry cleaning apparatus.

FIG. 19 A cross-sectional view of the slurry cleaning apparatus shown in FIG. 18, taken along line A-A.

FIG. 20 A cross-sectional view of the slurry cleaning apparatus.

FIG. 21 A cross-sectional view of the slurry cleaning apparatus shown in FIG. 20, taken along line B-B.

FIG. 22 A diagrammatic view showing the construction of the slurry cleaning system.

FIG. 23 A diagrammatic view showing the construction of the slurry cleaning system.

FIG. 24 A diagrammatic view showing the construction of the slurry cleaning system.

FIG. 25 A diagrammatic view showing the construction of the stacking-type slurry cleaning apparatus.

FIG. 26 A cross-sectional view of the stacking-type slurry cleaning apparatus.

### MODE FOR CARRYING OUT THE INVENTION

Hereinbelow, a toner for electrostatic image development and a method for producing the same are first described.

The toner for electrostatic image development and the method for producing the same will be described, and then the slurry cleaning apparatus of the present invention will be described in detail.

In the present specification, particularly, a toner for electrostatic image development containing toner matrix particles having a core/shell structure (capsule structure) and a method for producing the same are described.

<1. Core Particles>

The core particles contain a binder resin and a colorant. The core particles, if necessary, additionally contain, for example, a wax and a charge control agent.

The core particles can be produced by a pulverization method or a wet polymerization method.

When the core particles are produced by a pulverization method, for example, a binder resin, a colorant, and a wax are melt-kneaded together at a high temperature, and then subjected to pulverization step and classification step, obtaining core particles. The obtained core particles are dispersed in water using an emulsifying agent to obtain a slurry of the core particles. Further, the below-mentioned shell particles are added to the slurry of the core particles, forming a core/shell structure.

Examples of wet polymerization methods include a suspension polymerization method, an emulsion polymerization aggregation method, and a melt suspension method.

When the core particles are produced by a suspension polymerization method, a colorant and a wax are dissolved in a binder resin monomer, and then the resultant monomer solution is suspended as monomer drops in an aqueous medium using a mechanical shearing force. Then, the monomer is polymerized to obtain core particles.

When the core particles are produced by an emulsion polymerization aggregation method, a polymerizable monomer for a binder resin is first emulsified in an aqueous medium containing, for example, a polymerization initiator and an emulsifying agent. Then, the polymerizable monomer is polymerized while stirring to obtain polymer primary particles. Then, a colorant and, if necessary, for example, a charge control agent are added to the polymer primary particles to cause the polymer primary particles to suffer flocculation. The resultant flocculate particles are matured to obtain core particles.

When the core particles are produced by a melt suspension method, for example, a binder resin and a wax are dissolved in a solvent to obtain an oil phase. After the oil phase is obtained, the oil phase is suspended as oil drops in an aqueous medium. After the oil drops are suspended in the aqueous medium, the solvent is removed to obtain core particles.

For producing the core particles, among the wet polymerization methods, an emulsion polymerization aggregation method is preferably used because the emulsion polymerization aggregation method is advantageous in that it is easy to control the particle diameter and shape of the toner particles.

In the present invention, as a monomer component used for producing the binder resin, a monomer conventionally used in a binder resin for a toner can be used.

For example, a polymerizable monomer having an acid group (hereinafter, frequently referred to as “acid monomer”), a polymerizable monomer having a basic group (hereinafter, frequently referred to as “basic monomer”), or a polymerizable monomer having neither an acid group nor a basic group (hereinafter, frequently referred to as “another monomer”) can be used.

Examples of acid monomers include polymerizable monomers having a carboxyl group, such as acrylic acid, methacrylic acid, maleic acid, fumaric acid, and cinnamic acid; polymerizable monomers having a sulfonic acid group, such as sulfonated styrene; and polymerizable monomers having a sulfonamide group, such as vinylbenzenesulfonamide.

Examples of basic monomers include aromatic vinyl compounds having an amino group, such as aminostyrene; nitrogen- and heterocycle-containing polymerizable monomers, such as vinylpyridine and vinylpyrrolidone; and (meth)acrylates having an amino group, such as dimethylaminoethyl acrylate and diethylaminoethyl methacrylate.

The acid monomer and basic monomer as well as the radical monomer used in the present invention contribute to stabilization of the particles in water in the course of producing the toner matrix particles by a suspension polymerization method, an emulsion polymerization aggregation method, or a melt suspension method. These monomers may be used individually or in combination. Further, the above monomer may be present in the form of a salt accompanied by a counter ion.

Examples of polymerizable monomers constituting the binder resin include styrenes, such as styrene, methylstyrene, chlorostyrene, dichlorostyrene, p-tert-butylstyrene, p-n-butylstyrene, and p-n-nonylstyrene; acrylates, such as methyl acrylate, ethyl acrylate, propyl acrylate, n-butyl acrylate, isobutyl acrylate, hydroxyethyl acrylate, and 2-ethylhexyl acrylate; methacrylates, such as methyl methacrylate, ethyl methacrylate, propyl methacrylate, n-butyl methacrylate, isobutyl methacrylate, hydroxyethyl methacrylate, and 2-ethylhexyl methacrylate; and acrylamide, N-propylacrylamide, N,N-dimethylacrylamide, N,N-dipropylacrylamide, and N,N-dibutylacrylamide. The polymerizable monomers may be used individually or in combination.

When the binder resin is used as a crosslinking resin, a multifunctional monomer having radical polymerizability is used together with the above-mentioned polymerizable monomer. Examples of multifunctional monomers include divinylbenzene, hexanediol diacrylate, ethylene glycol dimethacrylate, diethylene glycol dimethacrylate, triethylene glycol dimethacrylate, tetraethylene glycol dimethacrylate, hexaethylene glycol dimethacrylate, nonaethylene glycol dimethacrylate, diethylene glycol diacrylate, triethylene glycol diacrylate, neopentyl glycol dimethacrylate, neopentyl glycol diacrylate, and diallyl phthalate. Further, a polymerizable monomer having a reactive group in the pendant group, for example, glycidyl methacrylate, methylolacrylamide, or acrolein can be used. Of these, preferred are radically polymerizable, difunctional polymerizable monomers, and especially preferred are divinylbenzene and hexanediol diacrylate. These multifunctional polymerizable monomers may be used individually or in combination.

With respect to the binder resin, the number average molecular weight as determined by gel permeation chromatography (hereinafter, referred to as “GPC”) is preferably 2,000 or more, more preferably 2,500 or more, further preferably 3,000 or more, and is preferably 50,000 or less, more preferably 40,000 or less, further preferably 35,000 or less. Further, the weight average molecular weight as determined by the same method is preferably 30,000 or more, more preferably 40,000 or more, further preferably 50,000 or more, and is preferably 2,000,000 or less, more preferably 1,000,000 or less, further preferably 500,000 or less. When the number average molecular weight and weight average molecular weight of the binder resin are in the above-mentioned respective ranges, the resultant toner has excellent durability, excellent storage properties, and excellent fixing properties.

For initiating polymerization for the binder resin, if necessary, a known polymerization initiator can be used or two or more known polymerization initiators can be used in combination. For example, a persulfate, such as potassium persulfate, sodium persulfate, or ammonium persulfate, a redox initiator comprising a combination of the above persulfate and a reducing agent, such as acid sodium sulfite, a water-soluble polymerization initiator, such as hydrogen peroxide, 4,4′-azobiscyanovaleric acid, t-butyl hydroperoxide, or cumene hydroperoxide, a redox initiator comprising a combination of the above water-soluble polymerization initiator and a reducing agent, such as a ferrous salt, or benzoyl peroxide, or 2,2′-azobis-isobutyronitrile is used. The above polymerization initiator may be added to the polymerization system with any of timing before adding the monomer, timing simultaneously with adding the monomer, and timing after adding the monomer. If necessary, these addition methods may be used in combination.

In the present invention, if necessary, a known chain transfer agent can be used. Specific examples of chain transfer agents include t-dodecylmercaptan, 2-mercaptoethanol, diisopropyl xanthate, carbon tetrachloride, and trichloroboromomethane. The chain transfer agents may be used individually or in combination. The chain transfer agent is used in an amount of 0 to 5% by weight, based on the weight of the polymerizable monomer.

In the present invention, if necessary, a known suspension stabilizer can be used. Specific examples of suspension stabilizers include calcium phosphate, magnesium phosphate, calcium hydroxide, and magnesium hydroxide. These may be used individually or in combination. The suspension stabilizer may be used in an amount of 1 to 10 parts by mass, relative to 100 parts by mass of the polymerizable monomer.

The polymerization initiator and suspension stabilizer may be individually added to the polymerization system with any of timing before adding the polymerizable monomer, timing simultaneously with adding the polymerizable monomer, and timing after adding the polymerizable monomer. If necessary, these addition methods may be used in combination.

In addition, for example, a pH adjustor, a polymerization degree regulator, or an anti-foaming agent can be appropriately added to the reaction system.

In the present invention, when the binder resin is produced by an emulsion polymerization method, a known emulsifying agent can be used. At least one emulsifying agent selected from a cationic surfactant, an anionine surfactant, and a nonionic surfactant is preferably used.

Examples of cationic surfactants include dodecylammonium chloride, dodecylammonium bromide, dodecyltrimethylammonium bromide, dodecylpyridinium chloride, dodecylpyridinium bromide, and hexadecyltrimethylammonium bromide. Examples of anionic surfactants include fatty acid soaps, such as sodium stearate and sodium dodecanoate, sodium dodecyl sulfate, sodium dodecylbenzenesulfonate, and sodium lauryl sulfate. Examples of nonionic surfactants include polyoxyethylene dodecyl ether, polyoxyethylene hexadecyl ether, polyoxyethylene nonyl phenyl ether, polyoxyethylene lauryl ether, polyoxyethylene sorbitan monooleate ether, and monodecanoylsucrose.

In the present invention, the amount of the emulsifying agent used is preferably 0.1 to 10 parts by mass, relative to 100 parts by mass of the polymerizable monomer. In the above emulsifying agent, for example, at least one polyvinyl alcohol, such as partially or completely saponified polyvinyl alcohol, or cellulose derivative, such as hydroxyethyl cellulose, can be used as a protective colloid.

In the present invention, the volume average particle diameter of the polymer primary particles obtained by an emulsion polymerization method is generally 0.02 μm or more, preferably 0.05 μm or more, further preferably 0.1 μm or more, and is generally 3 μm or less, preferably 2 μM or less, further preferably 1 μm or less. When the particle diameter is smaller than the above-mentioned range, control of the flocculation rate in the flocculation step is likely to be difficult. When the particle diameter is larger than the above-mentioned range, the particle diameter of the toner matrix particles obtained by flocculation is likely to be increased, making it difficult to obtain a toner having an intended particle diameter.

In the toner, a wax can be used as an offset preventing agent. In recent years, an attempt is made to improve the low-temperature fixing properties of the toner. There is generally a dilemma such that it is difficult to achieve both the low-temperature fixing properties of the toner and the blocking resistance and high-temperature offset resistance. For achieving both the mutually contradictory properties, the use of a wax as an offset preventing agent is preferred.

In the toner, a known wax can be arbitrarily used. Specific examples of waxes include olefin waxes, such as low molecular-weight polyethylene, low molecular-weight polypropylene, and copolymer polyethylene; paraffin waxes; ester waxes having a long-chain aliphatic group, such as behenyl behenate, a montanate, and stearyl stearate; vegetable waxes, such as a hydrogenated castor oil carnauba wax; ketones having a long-chain alkyl group, such as distearyl ketone; silicone having an alkyl group; higher fatty acids, such as stearic acid; long-chain fatty acid alcohols; long-chain fatty acid polyhydric alcohols, such as pentaerythritol, and partial esters thereof; and higher fatty acid amides, such as oleic acid amide and stearic acid amide. Preferred examples include hydrocarbon waxes, such as a paraffin wax and a Fischer-Tropsch wax, ester waxes, and silicone waxes.

In the present invention, the waxes may be used individually or in combination. For improving the fixing properties of the toner, the melting point of the wax is preferably 120° C. or lower, further preferably 110° C. or lower, especially preferably 100° C. or lower. The melting point of the wax is preferably 40° C. or higher, further preferably 50° C. or higher. When the melting point of the wax is too high, it is likely that the fixing temperature reducing effect for the toner cannot be obtained. When the melting point of the wax is too low, a problem about the setting properties or storage properties of the toner is likely to occur.

In the present invention, the amount of the wax is preferably 1 part by mass or more, more preferably 2 parts by mass or more, further preferably 5 parts by mass or more, relative to 100 parts by mass of the toner. The amount of the wax is preferably 40 parts by mass or less, more preferably 35 parts by mass or less, further preferably 30 parts by mass or less, relative to 100 parts by mass of the toner. When the amount of the wax contained in the toner is too small, performance, such as a high-temperature offset resistance, is likely to be unsatisfactory. When the amount of the wax contained in the toner is too large, it is likely that the blocking resistance is unsatisfactory or the wax bleeds from the toner to contaminate the apparatus.

In the polymerization method, as a method of incorporating the wax, it is preferred that the wax is preliminarily dispersed in water so as to have a volume average particle diameter of 0.01 to 2.0 μm. The particle diameter of the wax is preferably 1.0 μm or less, especially preferably 0.5 μm or less.

Further, in the emulsion polymerization aggregation method, it is preferred that a dispersion having dispersed therein the wax having an average particle diameter in the above-mentioned range is added upon emulsion polymerization or in the flocculation step.

For dispersing the wax having an advantageous particle diameter in the toner, it is preferred to use a method in which the wax is added as a seed upon emulsion polymerization, i.e., a so-called seed polymerization method. By adding the wax as a seed, the wax is finely and uniformly dispersed in the toner, making it possible to suppress deterioration of the charge properties or heat resistance of the toner.

A wax/long-chain polymerizable monomer dispersion can be prepared by preliminarily dispersing the wax in an aqueous dispersing medium, together with a long-chain polymerizable monomer, such as stearyl acrylate. A polymerizable monomer can also be polymerized in the presence of a wax/long-chain polymerizable monomer.

As a colorant to be contained in the core particles, a known colorant can be arbitrarily used. Specific examples of colorants include carbon black, aniline blue, phthalocyanine blue, phthalocyanine green, Hansa yellow, rhodamine dyes and pigments, chrome yellow, quinacridone, benzidine yellow, rose bengal, triallylmethane dyes, monoazo dyes and pigments, disazo dyes and pigments, and condensed azo dyes and pigments. A single type of the dyes and pigments may be solely used, or two or more types of the dyes and pigments may be used in combination. In the case of a full-color toner, with respect to yellow, benzidine yellow or a monoazo or condensed azo dye or pigment is preferably used. With respect to magenta, quinacridone or a monoazo dye or pigment is preferably used. With respect to cyan, phthalocyanine blue is preferably used. The amount of the colorant is preferably 3 to 20 parts by mass, relative to 100 parts by mass of the polymer primary particles.

In the emulsion polymerization aggregation method, the colorant is incorporated generally in the flocculation step. A dispersion of the polymer primary particles and a dispersion of the colorant particles are mixed together, and then these particles are caused to suffer flocculation, obtaining a particle flocculate. The colorant is preferably used in the state of being dispersed in water in the presence of an emulsifying agent. The volume average particle diameter of the colorant particles is 0.01 μm or more, more preferably 0.05 μm or more. The volume average particle diameter of the colorant particles is 3 μm or less, more preferably 1 μm or less.

The core particles in the present invention may be produced by any polymerization method, such as a suspension polymerization method, an emulsion polymerization aggregation method, or a dissolution suspension method, and there is no particular limitation.

When the core particles are produced by a suspension polymerization method, a colorant, a polymerization initiator, and, if necessary, a wax, a polar resin, a charge control agent, and a crosslinking agent are added to the above-mentioned monomer for binder resin. These additives are uniformly dissolved or dispersed in the monomer to prepare a monomer composition. The prepared monomer composition is dispersed in an aqueous medium containing, for example, a dispersion stabilizer. Preferably, the stirring speed and stirring time are controlled so that drops of the monomer composition have a desired size for the core particles. Then, the action of the dispersion stabilizer maintains the monomer composition in the state of particles. The monomer composition is stirred to an extent such that the particles of the monomer composition do not settle. These operations cause the monomer composition to undergo polymerization.

The obtained core particles are subjected to a step of cleaning the core particles usable as toner matrix particles and a step of drying the core particles, and then, if necessary, subjected to external additive treatment for the core particles. A toner for electrostatic image development can be produced from the core particles through these steps. The core particles can be cleaned by a general cleaning method. The core particles may be cleaned using the slurry cleaning apparatus of the present invention. Taking the cleaning efficiency into consideration, the cleaning apparatus of the present invention is preferably used.

For further improving the performance of the toner, it is preferred that the core particles are cleaned using the slurry cleaning apparatus of the present invention. It is preferred that the core particles are cleaned and then the below-described shell particles are added to the core particles. By adding the shell particles to the core particles, a core/shell structure can be formed.

When the core particles are produced by an emulsion polymerization aggregation method, a colorant dispersion and a wax dispersion are first prepared. Then, polymer primary particles of a binder resin monomer obtained by emulsion polymerization, or polymer primary particles of a wax-included binder resin monomer obtained by emulsion polymerization in the presence of a wax dispersion are prepared. Then, the colorant dispersion, the wax dispersion, and the polymer primary particles of the binder resin monomer are mixed together. Subsequently, the resultant mixture is heated, and subjected to flocculation and maturing steps, producing core particles.

The core particles are produced by an emulsion polymerization aggregation method, and then, as described below, the surface of the core particles is covered with shell particles (encapsulation step). Toner matrix particles having a core/shell structure can be produced through the encapsulation step.

Among the above-mentioned methods for producing the core particles by the emulsion polymerization aggregation method, a method in which a colorant dispersion is added in the flocculation step is preferred. The reason for this is that when a binder resin monomer is subjected to polymerization in the presence of a colorant, the metal contained in the colorant adversely affects the radical polymerization. In this case, it is difficult to control the molecular weight or rheology of the resin produced, and therefore there is a danger that desired polymer primary particles cannot be obtained.

In the emulsion polymerization aggregation method, the polymer primary particles, colorant particles, and wax, and, if necessary, a charge control agent may be mixed together at the same, or may be successively mixed with one another. Alternatively, dispersions of the respective components may be individually prepared and then mixed together.

When the core particles are produced by the emulsion polymerization aggregation method, it is preferred that the flocculation step is performed in a vessel having a stirring apparatus. In this case, the particle diameter of the particle flocculate can be controlled by the balance between the cohesive force of the particles and the shearing force caused by stirring. Further, by heating the mixture containing the polymer primary particles or adding an electrolyte to the mixture, the cohesive force of the polymer primary particles can be increased.

In the present invention, when flocculation is performed by adding an electrolyte, the electrolyte to be used may be any of an acid, an alkali, a salt, an organic electrolyte, and an inorganic electrolyte. Specifically, examples of acids include hydrochloric acid, nitric acid, sulfuric acid, and citric acid. Examples of alkalis include sodium hydroxide, potassium hydroxide, and aqueous ammonia. Examples of salts include NaCl, KCl, LiCl, Na₂SO₄, K₂SO₄, Li₂SO₄, MgCl₂, CaCl₂, MgSO₄, CaSO₄, ZnSO₄, Al₂(SO₄)₃, Fe₂(SO₄)₃, CH₃COONa, and C₆H₅SO₃Na. Of these, inorganic salts having divalent or multivalent metal cations are preferred.

In the present invention, the amount of the electrolyte added varies depending on, for example, the type of the electrolyte and the intended particle diameter. The amount of the electrolyte added is preferably 0.02 part by mass or more, further preferably 0.05 part by mass or more, relative to 100 parts by mass of the mixture dispersion in terms of a solids content. The amount of the electrolyte added is preferably 25 parts by mass or less, further preferably 15 parts by mass or less, especially preferably 10 parts by mass or less, relative to 100 parts by mass of the mixture dispersion in terms of a solids content. When the amount of the electrolyte added is too small, the flocculation reaction proceeds slowly. When the flocculation reaction proceeds slowly, a problem is likely to occur in that 1 μm or less fine powder remains after the flocculation reaction, or in that the average particle diameter of the obtained particle flocculate is less than an intended particle diameter. When the amount of the electrolyte added is too large, the flocculation reaction tends to rapidly proceed. When the flocculation reaction rapidly proceeds, it is difficult to control the particle diameter, and therefore a problem is likely to occur in that the obtained particle flocculate contains coarse powder or those in an indefinite form. When an electrolyte is added to cause flocculation, the flocculation temperature is 20° C. or higher, preferably 30° C. or higher, and is 80° C. or lower, preferably 70° C. or lower.

The time required for the flocculation is optimized according to the form of the apparatus or the scale for the treatment. For achieving the core particles having an intended particle diameter, it is preferred that the above-mentioned predetermined temperature is maintained generally for 30 minutes or more. The temperature elevation to the predetermined temperature may be either temperature elevation at a constant rate or stepwise temperature elevation.

By controlling the structure of the toner, performance of the toner, such as charge properties or storage stability, can be improved. For controlling the structure of the toner, it is preferred that polymer primary particles are further added to the obtained particle flocculate to form a capsule layer on the surface of the particle flocculate. The polymer primary particles further added may be the same as or different from the polymer primary particles for the core particle flocculate.

For improving the stability of the particle flocculate obtained in the flocculation step, it is preferred to fuse the particles together in the maturing step subsequent to the flocculation step. The temperature for the maturing step is preferably the Tg of the polymer primary particles or higher, more preferably Tg+5° C. or higher. The temperature for the maturing step is preferably Tg+80° C. or lower, more preferably Tg+50° C. or lower. The period of time required for the maturing step varies depending on the shape of the intended core particles. In the maturing step, after the temperature of the particle flocculate has reached the glass transition temperature of the polymer primary particles or higher, that temperature is preferably maintained generally for 0.1 to 10 hours, preferably 1 to 6 hours.

It is preferred that, in the stage in or after the flocculation step, preferably in the stage before the maturing step or in the maturing step, a surfactant is added to the particle flocculate, or the pH is increased, or a surfactant is added to the particle flocculate and the pH is increased. As a surfactant, at least one emulsifying agent selected from the emulsifying agents which can be used in producing the polymer primary particles can be used. Particularly, the same emulsifying agent as the emulsifying agent used in producing the polymer primary particles is preferably used. With respect to the amount of the surfactant added, there is no particular limitation. The amount of the surfactant added is preferably 0.1 part by mass or more, more preferably 0.3 part by mass or more, relative to 100 parts by mass of the mixture dispersion in terms of a solids content. The amount of the surfactant added is preferably 20 parts by mass or less, more preferably 15 parts by mass or less, further preferably 10 parts by mass or less, relative to 100 parts by mass of the mixture dispersion in terms of a solids content.

A surfactant can be added or the pH can be increased in or after the flocculation step and before completion of the maturing step. In this case, not only can, for example, flocculation of the particle flocculate formed in the flocculation step be suppressed, but also the formation of coarse particles after the maturing step can be suppressed.

By the heating treatment performed in the maturing step, the polymer primary particles in the flocculate are fused and unified together. When the polymer primary particles are fused and unified together, the shape of the core particles as flocculate becomes nearly spherical. The particle flocculate before subjected to the maturing step is considered to be an aggregate of the polymer primary particles which have suffered electrostatic or physical flocculation. After subjected to the maturing step, the polymer primary particles constituting the particle flocculate are fused together, so that the shape of the core particles becomes nearly spherical. By controlling, for example, the temperature and time for the maturing step, the shape of the flocculate of the polymer primary particles can be controlled. For example, the shape of the flocculate can be controlled to be a grape-like shape, a potato-like shape caused by fusion which has proceeded, or a spherical shape caused by fusion which has further proceeded. Thus, the core particles having various shapes can be produced according to the purpose.

The obtained core particles can be used as toner matrix particles. A toner for electrostatic image development can be obtained by subjecting the toner matrix particles to a cleaning step and a drying step, and, if necessary, external additive treatment. The toner matrix particles may be cleaned by a general method. The toner matrix particles may be cleaned using the slurry cleaning apparatus of the present invention. Taking the cleaning efficiency into consideration, it is preferred to use the cleaning apparatus of the present invention.

For further improving the performance of the toner, the core particles are cleaned using the slurry cleaning apparatus of the present invention, and then the below-mentioned shell particles are added to the resultant core particles. By adding the shell particles, a core/shell structure can be formed.

In the case of the other wet polymerization method, such as a melt suspension method, like the above-mentioned suspension polymerization method and emulsion polymerization aggregation method, toner matrix particles can be produced through the cleaning and drying steps for the core particles. Alternatively, the slurry is cleaned to remove impurities contained in the slurry, excluding the core particles, to some extent, and then, as mentioned below, the surface of the core particles is covered with shell particles, producing toner matrix particles having a core/shell structure.

<2. Shell Particles>

In the present invention, the shell particles covering the surface of the core particles may be either inorganic particles or resin particles, and there is no particular limitation. The shell particles are also called as “shell agent”.

When the shell particles are resin particles, there is no particular limitation, but, as a raw material for the shell particles, for example, a styrene, acrylic, or ester resin used as a general toner binder resin, or a resin of a copolymer system or blend system thereof can be used. The shell particles can be produced by emulsifying a resin, or can be produced by a polymerization method, such as an emulsion polymerization or a suspension polymerization. From the viewpoint of facilitating the control of the particle diameter and the formation of fine particles, the shell particles are preferably produced using a polymerization method. From the viewpoint of facilitating the control of the particle diameter and particle size distribution of the fine particles, the shell particles are especially preferably produced using an emulsion polymerization method.

With respect to the volume average particle diameter of the shell particles, there is no particular limitation, but the volume average particle diameter of the shell particles is preferably 20 nm or more, further preferably 50 nm or more. The volume average particle diameter of the shell particles is preferably 500 nm or less, further preferably 150 nm or less.

The weight average molecular weight of the shell particles is preferably 2,000 to 30,000, more preferably 4,000 to 25,000, especially preferably 6,000 to 20,000.

With respect to the glass transition temperature of the shell particles, there is no particular limitation, but the glass transition temperature of the shell particles is 40° C. or higher, preferably 45° C. or higher. On the other hand, the glass transition temperature of the shell particles is 100° C. or lower, preferably 80° C. or lower, further preferably 75° C. or lower.

For improving the blocking resistance of the toner, it is preferred that the glass transition temperature (Tg) of the shell particles is higher than the glass transition temperature (Tg) of the core particles.

The glass transition temperature (Tg) of the shell particles is preferably the glass transition temperature (Tg) of the core particles or higher, more preferably (the glass transition temperature (Tg) of the core particles+2° C.) or higher, further preferably (the glass transition temperature (Tg) of the core particles+5° C.) or higher. On the other hand, the glass transition temperature (Tg) of the shell particles is preferably (the glass transition temperature (Tg) of the core particles+50° C.) or lower, more preferably (the glass transition temperature (Tg) of the core particles+30° C.) or lower, further preferably (the glass transition temperature (Tg) of the core particles+20° C.) or lower.

When the weight average molecular weight and glass transition temperature of the shell particles are too low, the blocking resistance of the toner is likely to become poor. On the other hand, when the weight average molecular weight and glass transition temperature of the shell particles are too high, the low-temperature fixing properties of the toner are likely to become poor.

The content of the shell particles is 0.01 wt % or more, preferably 0.3 wt % or more, based on the weight of the toner matrix particles.

The content of the shell particles is preferably 10 wt % or less, based on the weight of the toner matrix particles.

The shell particles may be either non-electrostatic or electrostatic according to the purpose of the use.

The toner having a core/shell structure in the present invention can achieve both the low-temperature fixing properties and the blocking resistance, and further the electrostatic property of the toner can be controlled by using the electrostatic shell particles.

The electrostatic property of the toner is generally controlled by a charge control agent, a binder resin, or an external additive. As a charge control agent, generally, an inorganic charge control agent is used. In recent years, a resin having the charge controlling ability (charge control resin) is used as a charge control agent. The electrostatic property is controlled by introducing various functional groups into the binder resin and utilizing the properties of the functional group. For example, in the case of a positively charged toner, the electrostatic property can be controlled by copolymerizing a monomer having an amino group or an amide bond with the binder resin.

As a method for controlling the electrostatic property of the toner, generally, there has been known a method in which a charge control agent is dispersed in a binder resin for the toner. There has also been known a method in which a polymerizable monomer having the charge controlling ability (charge control resin) is copolymerized with a binder resin. However, when the dispersion of the charge control agent or charge control resin in the toner matrix particles or on the surface of the toner matrix particles is not uniform, a problem, such as an increase of the occurrence of fog or scattering of the toner, is caused. For this reason, in the small particle-diameter toner recently used in an attempt to improve the high definition image quality, the charge control agent or charge control resin is required to have more uniform dispersibility. Generally, it is said that the electrostatic property of the toner is controlled by the performance of the resin on the surface of the toner.

When the charge control agent or charge control resin is uniformly dispersed in the binder resin for toner, for obtaining a satisfactory charge control effect, it is necessary to add the charge control agent or charge control resin in a large amount. Therefore, the low-temperature fixing properties of the toner may become poor due to the increase of the amount of the charge control agent or charge control resin added.

For such a reason, it is preferred that the charge control agent or charge control resin is dispersed in a larger amount on the surface side of the toner particles. In the toner matrix particles obtained by a polymerization method, particularly in the toner matrix particles obtained by an emulsion flocculation method, the above-mentioned control is easy, as compared to that in the toner matrix particles obtained by a pulverization method. Specifically, in the toner matrix particles obtained by a polymerization method, by changing the timing of adding or mixing the charge control agent or charge control resin, the position in the toner matrix particles, in which the charge control agent or charge control resin is dispersed, can be easily controlled.

When an electrostatic property is imparted to the toner matrix particles, it is preferred that a charge control agent or a charge control resin is added to the shell particles so that the shell layer in the core/shell structure has the charge control ability.

When the shell particles are resin fine particles, it is preferred that a resin used in the shell particles is copolymerized with a charge control resin.

When the shell particles are positively charged resin fine particles, examples of charge control resins include resins containing an amino group, such as —NH₂, —NHCH₃, —N(CH₃)₂, —NHC₂H₅, —N(C₂H₅)₂, or —NHC₂H₄OH; and resins containing a quaternary ammonium salt which are obtained by changing the amino group of the above resins to an ammonium salt. Of these, preferred are resins containing a quaternary ammonium salt.

Such a positively charged charge control resin can be obtained by, for example, copolymerizing a mono vinyl monomer containing an amino group with a monomer copolymerizable with the monovinyl monomer. Alternatively, the positively charged charge control resin can be obtained by changing a copolymer containing an amino group to an ammonium salt thereof. A resin containing a quaternary ammonium salt can also be obtained by copolymerizing a monovinyl monomer containing an ammonium salt group with a monovinyl monomer copolymerizable with the monovinyl monomer. The method for producing the positively charged charge control resin is not limited to these methods. As a monomer to be copolymerized, a monomer generally used for a binder resin can be used.

The positively charged charge control resin is preferably a resin containing a quaternary ammonium salt group. Of the resins containing a quaternary ammonium salt group, an acrylate containing a quaternary ammonium salt and being represented by the structural formula (1) below, and an acrylamide containing a quaternary ammonium salt and being represented by the structural formula (2) below are preferred, and an acrylate containing a quaternary ammonium salt and being represented by the structural formula (1) below is more preferred.

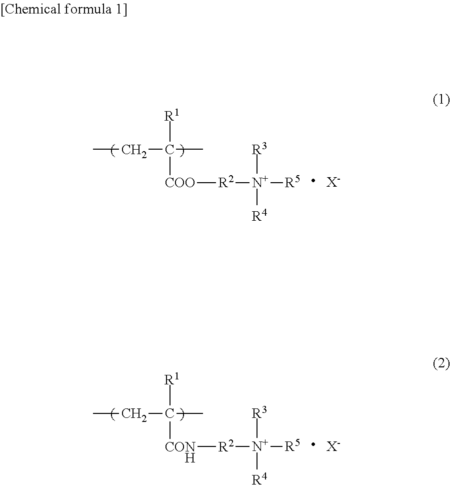

In the structural formulae (1) and (2) above, R¹ is a hydrogen atom or a methyl group, R² is an alkylene group, each of R³, R⁴, and R⁵ is independently a hydrogen atom or a linear, branched, or cyclic alkyl group having 1 to 6 carbon atoms, and X— is a halogen ion, a benzenesulfonic acid ion, or an alkylbenzenesulfonic acid ion.

In the quaternary ammonium salt represented by the structural formula (1) above, X— is preferably a chloride ion or a toluenesulfonic acid ion, R¹ is preferably a hydrogen atom or a methyl group, R² is preferably an alkylene group having 1 to 3 carbon atoms, such as CH₂, C₂H₄, or C₃H₆, or a derivative thereof, and each of R³ to R⁵ is preferably independently an alkyl group, such as CH₃, C₂H₅, or C₃H₇.

Examples of amino group-containing (meth)acrylate monomers include N,N-disubstituted aminoalkyl (meth)acrylate compounds, such as dimethylaminomethyl (meth)acrylate, diethylaminomethyl (meth)acrylate, dipropylaminomethyl (meth)acrylate, diisopropylaminomethyl (meth)acrylate, ethylmethylaminomethyl (meth)acrylate, methylpropylaminomethyl (meth)acrylate, dimethylamino-1-ethyl (meth)acrylate, diethylamino-1-ethyl (meth)acrylate, dipropylamino-1-ethyl (meth)acrylate, diisopropylamino-1-ethyl (meth)acrylate, ethylmethylamino-1-ethyl (meth)acrylate, methylpropylamino-1-ethyl (meth)acrylate, dimethylamino-2-ethyl (meth)acrylate, diethylamino-2-ethyl (meth)acrylate, dipropylamino-2-ethyl (meth)acrylate, diisopropylamino-2-ethyl (meth)acrylate, ethylmethylamino-2-ethyl (meth)acrylate, methylpropylamino-2-ethyl (meth)acrylate, dimethylamino-1-propyl (meth)acrylate, diethylamino-1-propyl (meth)acrylate, dipropylamino-1-propyl (meth)acrylate, diisopropylamino-1-propyl (meth)acrylate, ethylmethylamino-1-propyl (meth)acrylate, methylpropylamino-1-propyl (meth)acrylate, dimethylamino-2-propyl (meth)acrylate, diethylamino-2-propyl (meth)acrylate, dipropylamino-2-propyl (meth)acrylate, diisopropylamino-2-propyl (meth)acrylate, ethylmethylamino-2-propyl (meth)acrylate, and methylpropylamino-2-propyl (meth)acrylate.

Examples of quaternization agents used for changing a copolymer to an ammonium salt thereof include alkyl halides, such as methyl iodide, ethyl iodide, methyl bromide, and ethyl bromide; and alkyl paratoluenesulfonates, such as methyl paratoluenesulfonate, ethyl paratoluenesulfonate, and propyl paratoluenesulfonate.

As a commercially available quaternary ammonium salt group-containing (meth)acrylate monomer, for example, there is BLEMMER QA (manufactured by NOF Corporation).

The amount of the electrostatic monomer units having a functional group, such as an amino group or an ammonium salt group, is preferably 0.5 to 15% by weight, more preferably 1 to 12% by weight, especially preferably 2 to 10% by weight, based on the weight of the charge control resin. When the amount of the monomer units having a functional group is too small, a large amount of the charge control resin is needed for obtaining the required charge amount, so that the toner is likely to be lowered in environmental stability. When the amount of the monomer units having a functional group is too large, a lowering of the charge amount of the toner at a high temperature and at a high humidity is likely to be marked, leading to the occurrence of fog.

With respect to the positively charged charge control resin, various commercially available products can be used. For example, there can be mentioned FCA-161P (styrene/acrylic resin), FCA-207P (styrene/acrylic resin), and FCA-201-PS (styrene/acrylic resin), each of which is manufactured by Fujikura Kasei Co., Ltd.

With respect to the negatively charged charge control resin, there is no particular limitation, but a resin generally used for a negatively charged toner, for example, a styrene-acrylic resin or a polyester resin can be used. A commercially available negatively charged charge control resin can also be used.

The shell particles can be produced by emulsifying a charge control resin. The shell particles can also be produced by subjecting a charge control resin to, for example, emulsion polymerization or suspension polymerization. From the viewpoint of facilitating the control of the particle diameter of the shell particles and the formation of fine particles, a polymerization method is preferred. From the viewpoint of facilitating the control of the particle diameter and particle size distribution of the shell particles, an emulsion polymerization method is further preferred.

When the charge control resin is used in producing the shell particles, core particles, or toner matrix particles, with respect to the amount of the electrostatic monomer contained, there is no particular limitation, but the amount of the electrostatic monomer contained is 0.01 wt % or more, preferably 0.05 wt % or more, more preferably 0.1 wt % or more, based on the weight of the toner matrix particles. On the other hand, the amount of the electrostatic monomer contained is 5 wt % or less, preferably 2 wt % or less, more preferably 1 wt % or less.

<3. Method for Covering the Core Particles with Shell Particles (Encapsulation step)>

Hereinafter, the step of covering the core particles with shell particles is frequently referred to as “encapsulation step”. The control for covering the core particles with the shell particles is frequently referred to as “encapsulation control”.

The method of performing the encapsulation step includes the following two methods.

(1) A method in which a shell particle component is mixed into core particles in the latter half of the step of forming the core particles to form a capsule structure.

(2) A method in which core particles are formed and then the surface of the core particles is covered with shell particles to form a capsule structure.

In the case of method (1) above, the shell particles adhere to the core particles being formed. Therefore, the shell particles are easily embedded in the core particles, so that the adhesion strength of the shell particles to the core particles is increased. Meanwhile, the shell particles are embedded in the surface of the core particles and therefore, a larger amount of the shell particles are needed for completely covering the core particles with the shell particles (encapsulation).

In the case of method (2) above, the surface of the completed core particles is covered with the shell particles. Therefore, the shell particles are likely to remain on the surface of the core particles, making it possible to form a shell layer having a uniform thickness from a smaller amount of the shell particles.

In the encapsulation step, it is preferred that the polarity of charge of the core particles and the polarity of charge of the shell particles are opposite. In this case, it is possible to cause the shell particles to electrostatically adhere to the surface of the core particles. This electrostatic adhesion makes it possible to improve the adhesion efficiency (encapsulation efficiency) of the shell particles to the core particles, so that exposure of the core particles can be prevented. Further, electrostatic repulsion between the shell particles makes it possible to form a shell layer having a uniform thickness and being nearly a single layer from a smaller amount of the shell particles on the surface of the core particles. The thickness of the single-layer shell layer formed by electrostatic adhesion of the shell particles is almost the same as the volume average particle diameter of the shell particles. With respect to the thickness of the single-layer shell layer, there is no particular limitation, but the thickness of the single-layer shell layer is 20 nm or more, preferably 50 nm or more, and is 500 nm or less, preferably 150 nm or less.

Further, a double-layer shell layer can be formed by forming a shell layer from shell particles having certain polarity of charge, and then further forming a shell layer from shell particles having polarity opposite to the polarity of the above shell particles. A multilayer shell layer can be formed by repeating the above-mentioned formation of a shell layer.

In the step of covering the core particles with the shell particles (encapsulation step), the shell particles can be directly added to and mixed into a dispersion of the core particles. When using the core particles obtained by a pulverization method, a dispersion having the core particles dispersed therein using an emulsifying agent can be used. When using the core particles obtained by a polymerization method, the slurry obtained after the core particles are produced can be used as such. For performing more precise encapsulation control, it is preferred that the emulsifying agent present in the core particle dispersion is removed by a method of, for example, cleaning to such an extent that flocculate of the core particles is not caused.

With respect to the mixing temperature for the core particles and shell particles in the encapsulation step, there is no particular limitation, but the mixing temperature is preferably a temperature which is lower by 10° C. or more than the Tg of the core particles or the Tg of the shell particles, which Tg is lower than the other. When the mixing temperature is in the above range, not only can the generation of flocculate of the particles be prevented, but also the core particles and the shell particles can be uniformly mixed with each other.

<4. Cleaning and Drying of the Toner Matrix Particles>

The core particles are covered with the shell particles, producing the toner matrix particles. After the step of cleaning the toner matrix particles and the step of drying the toner matrix particles, if necessary, the toner matrix particles are subjected to external additive treatment. A toner for electrostatic image development is produced from the toner matrix particles through the cleaning step and drying step, and, if necessary, an external additive treatment.

The toner matrix particles can be cleaned using water. The toner matrix particles can also be cleaned with an aqueous solution of an alkali or an acid. The toner matrix particles can also be cleaned with warm water or hot water. These methods can be used in combination. By performing such a cleaning step, the suspension stabilizer, emulsifying agent, unreacted residual monomer and others can be reduced or removed. The cleaned toner matrix particles are recovered. The recovered toner matrix particles are preferably in a wet cake form. When the recovered toner matrix particles are in a wet cake form, handling of the toner matrix particles is easy in the subsequent drying step.

In the drying step, for example, a fluidized-bed drying method, such as a vibration-type fluidized-bed drying method or a circulation-type fluidized-bed drying method, a flash drying method, a vacuum drying method, a freeze drying method, a spray drying method, or a flash jet drying method is used. Operation conditions in the drying step, such as the temperature, the air flow rate, and the degree of vacuum, are optimized according to, for example, the Tg of the coloring particles, or the form, mechanism, or size of the apparatus used.

The volume average particle diameter of the toner matrix particles is preferably 3 μm or more, more preferably 5 μm or more. The volume average particle diameter of the toner matrix particles is preferably 15 μm or less, more preferably 10 μm or less.

The average roundness of the toner matrix particles is preferably 0.90 or more, more preferably 0.92 or more, further preferably 0.94 or more. The average roundness of the toner matrix particles is preferably 0.99 or less. The average roundness of the toner matrix particles can be measured using Flow-type particle image analyzer FPIA-3000. When the average roundness of the toner matrix particles is too small, a failure of adhesion of an external additive to the coloring particles causes the electrostatic property of the coloring particles to be poor. When the electrostatic property of the coloring particles becomes poor, the image density is likely to be lowered. On the other hand, when the average roundness of the toner matrix particles is too large, a cleaning failure is likely to be caused due to the shape of the coloring particles.

The glass transition point Tg of the toner as measured by a DSC method is preferably 40° C. or higher, more preferably 50° C. or higher. The glass transition point Tg of the toner as measured by a DSC method is preferably 80° C. or lower, more preferably 70° C. or lower. When the Tg of the toner is in the above-mentioned range, the toner has excellent storage properties and excellent fixing properties.

<5. External Additive (External-Additive Fine Particles)>

In the present invention, for improving the flowability or charge control performance of the toner, if necessary, external-additive fine particles are added to the toner. As the external-additive fine particles, for example, inorganic fine particles or organic fine particles can be used.

As inorganic fine particles, there can be used various carbides, such as silicon carbide, boron carbide, titanium carbide, zirconium carbide, hafnium carbide, vanadium carbide, tantalum carbide, niobium carbide, tungsten carbide, chromium carbide, molybdenum carbide, and calcium carbide; various nitrides, such as boron nitride, titanium nitride, and zirconium nitride; various borides, such as zirconium boride; various oxides, such as titanium oxide, calcium oxide, magnesium oxide, zinc oxide, copper oxide, aluminum oxide, cerium oxide, silica, and colloidal silica; various titanate compounds, such as calcium titanate, magnesium titanate, and strontium titanate; phosphate compounds, such as calcium phosphate; sulfides, such as molybdenum disulfide; fluorides, such as magnesium fluoride and carbon fluoride; various metallic soaps, such as aluminum stearate, calcium stearate, zinc stearate, and magnesium stearate; talc, bentonite, various carbon black and conductive carbon black, magnetite, and ferrite. As organic fine particles, fine particles of, for example, a styrene resin, an acrylic resin, an epoxy resin, or a melamine resin can be used.

Among these external-additive fine particles, particularly, for example, silica, titanium oxide, alumina, zinc oxide, various carbon black, or conductive carbon black is preferably used. Further, the external-additive fine particles may be the above-mentioned inorganic or organic fine particles having the surface thereof subjected to treatment of, for example, rendering the surface hydrophobic. Examples of treatment agents used in the surface treatment include silane coupling agents, such as hexamethyldisilazane (HMDS) and dimethyldichlorosilane (DMDS); titanate coupling agents; silicone oil treatment agents, such as a silicone oil, a dimethylsilicone oil, a modified silicone oil, and an amino-modified silicone oil; silicone varnishes, fluorine silane coupling agents, fluorine silicone oils, and coupling agents having an amino group or a quaternary ammonium salt group. The treatment agents can be used in combination.

From the viewpoint of the charge control, as an external additive, conductive fine particles are preferably added to the toner. The resistance of the conductive fine particles is 400 Ω·cm or less, preferably 200 Ω·cm or less, more preferably 100 Ω·cm or less, further preferably 60 Ω·cm or less. The resistance of the conductive fine particles is 0.1 Ω·cm or more, preferably 1 Ω·cm or more, more preferably 5 Ω·cm or more, further preferably 15 Ω·cm.

As the external additive, conductive fine particles can be used. Examples of conductive fine particles include metal oxides, such as conductive titanium oxide, silica, and magnetite, and those which are doped with a conductive substance; organic fine particles obtained by doping a polymer having a conjugated double bond, such as polyacetylene, polyphenylacetylene, or poly-p-phenylene, with a conductive substance, such as a metal; and carbon, such as carbon black and graphite. Among these conductive fine particles, preferred is conductive titanium oxide or the conductive titanium oxide which is doped with a conductive substance. These conductive fine particles can impart conductive properties to the toner without sacrificing the flowability of the toner. The amount of the conductive fine particles contained is 0.05 part by mass or more, preferably 0.1 part by mass or more, more preferably 0.2 part by mass or more, relative to 100 parts by mass of the toner matrix particles. The amount of the conductive fine particles contained is 3 parts by mass or less, preferably 2 parts by mass or less, more preferably 1 part by mass or less, relative to 100 parts by mass of the toner matrix particles.

In the present invention, when external-additive fine particles other than the conductive fine particles are used, the amount of the external-additive fine particles contained is preferably 0.5 part by mass or more, more preferably 0.8 part by mass or more, and is preferably 5 parts by mass or less, more preferably 4 parts by mass or less, relative to 100 parts by mass of the toner matrix particles.

With respect to the method for adding an external additive to the toner, there is no particular limitation. For example, using a high-speed stirrer, such as a Henschel mixer, the toner and an external additive can be mixed with each other. When two or more types of external additives are added to the toner, the two or more types of external additives may be added at the same time, or the two or more types of external additives may be divided into a plurality of portions and added portion by portion.

<6. Slurry Cleaning Apparatus>

Hereinabove, the toner for electrostatic image development containing toner matrix particles having a core/shell structure and the method for producing the same were described in detail. Hereinbelow, a slurry cleaning apparatus that can be used in producing the toner matrix particles having a core/shell structure will be described in detail.

The slurry cleaning apparatus of the present invention can be preferably used in cleaning a slurry containing toner matrix particles. Further, the slurry cleaning apparatus of the present invention can be preferably used in cleaning a slurry containing resin fine particles, such as core particles or shell particles.

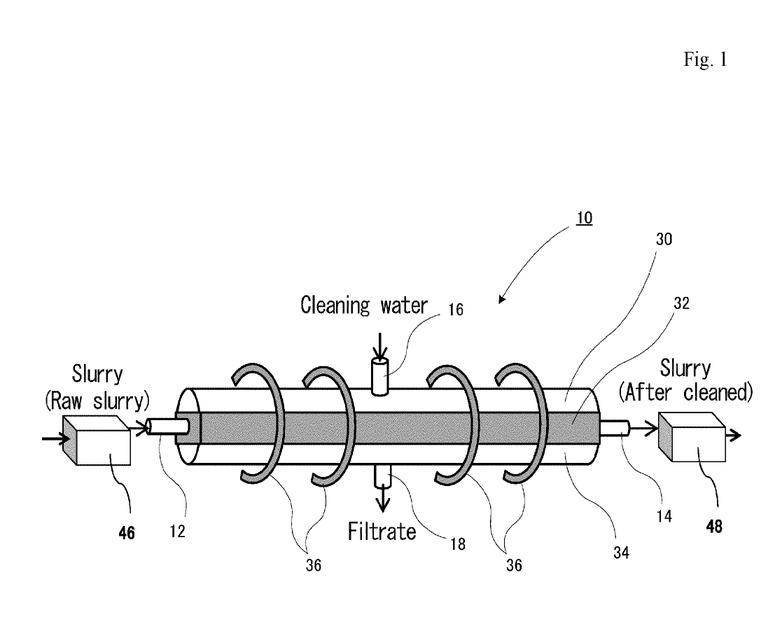

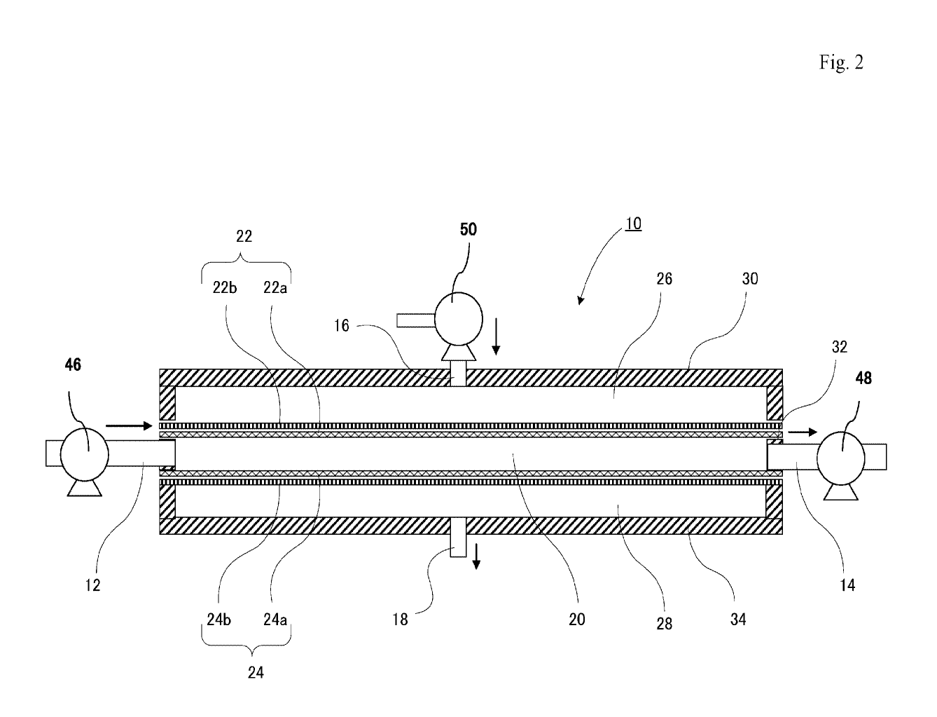

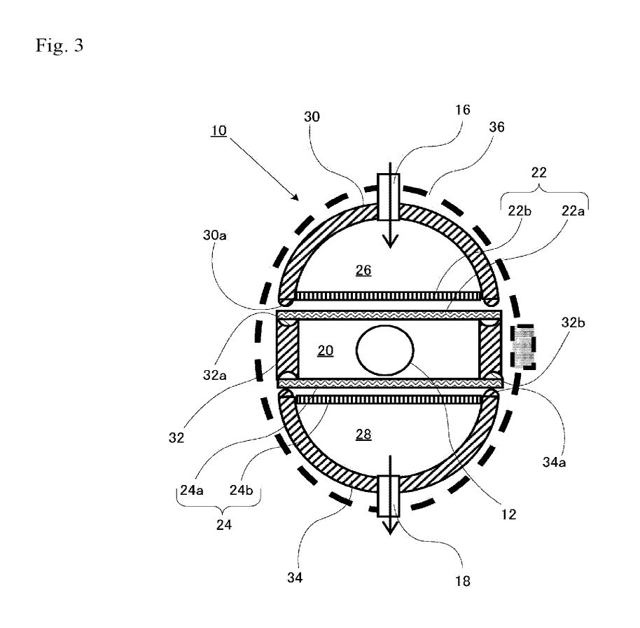

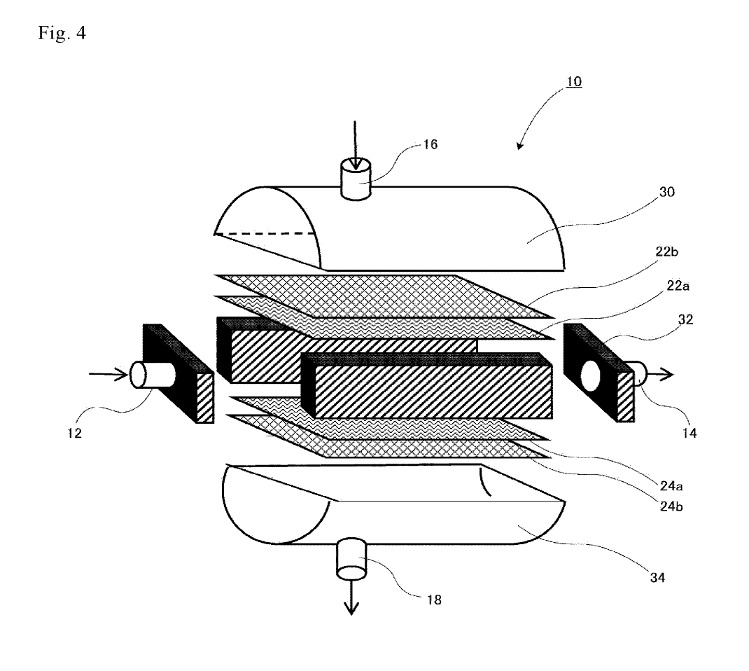

FIG. 1 is a diagrammatic view showing the construction of the slurry cleaning apparatus. FIGS. 2 and 3 are cross-sectional views of the slurry cleaning apparatus. FIG. 4 is an exploded perspective view of the slurry cleaning apparatus.

As shown in FIG. 1, slurry cleaning of the present invention has slurry inlet 12 through which a slurry is fed, slurry feed device 46 which is a device for feeding the slurry quantitatively (at a constant flow rate), slurry outlet 14 through which the slurry is discharged, slurry discharge device 48 which is a device for controlling the amount of the slurry discharged, cleaning water inlet 16 through which cleaning water is fed, and cleaning water outlet 18 through which the cleaning water is discharged.

As shown in FIG. 2, slurry cleaning apparatus 10 has cleaning chamber 20. Cleaning chamber 20 is a space in which the slurry and cleaning water are contacted with each other to clean the slurry. By cleaning the slurry, excess components contained in the slurry, such as a surfactant, can be removed.

Cleaning chamber 20 has first filtration side 22 and second filtration side 24 each having water permeability. First filtration side 22 is disposed on the upper side of cleaning chamber 20. Second filtration side 24 is disposed on the lower side of cleaning chamber 20. First filtration side 22 and second filtration side 24 are arranged in substantially parallel with each other. The slurry fed quantitatively by slurry feed device 46 to cleaning chamber 20 through slurry inlet 12 passes between first filtration side 22 and second filtration side 24, and then is quantitatively discharged by slurry discharge device 48 to the outside through slurry outlet 14.

Slurry feed device 46 and slurry discharge device 48 are a device that can control the flow rate of the slurry. Slurry feed device 46 and slurry discharge device 48 individually comprise, for example, a constant delivery pump, a flow rate controller, or a pressure regulating valve. The flow rate of the slurry can be controlled by slurry feed device 46 and slurry discharge device 48. By controlling the flow rate of the slurry, it is possible to adjust the concentration of the cleaned slurry.

Cleaning water storage chamber 26 is provided above cleaning chamber 20 through first filtration side 22. On the other hand, filtrate storage chamber 28 is provided below cleaning chamber 20 through second filtration side 24.

The cleaning water is fed through cleaning water inlet 16. Cleaning water feed device 50 for feeding the cleaning water to cleaning chamber 20 at a constant flow rate is located at cleaning water inlet 16. From the viewpoint of facilitating the control of the cleaning water flow rate, cleaning water feed device 50 is preferably a flow rate controller, such as a constant delivery pump or a flow rate valve. The flow rate of the slurry and the concentration of the slurry in cleaning chamber 20 can be controlled by the flow rate of the cleaning water fed by cleaning water feed device 50.

The cleaning water is once stored in cleaning water storage chamber 26, and then passes through first filtration side 22 and flows into cleaning chamber 20. The cleaning water in cleaning chamber 20 is brought into contact with the slurry in cleaning chamber 20, and then passes through second filtration side 24 and flows into filtrate storage chamber 28. The cleaning water (filtrate) in filtrate storage chamber 28 is discharged to the outside through cleaning water outlet 18.

The filtration method may be either pressure filtration or filtration under a reduced pressure. In the case of pressure filtration, a pressure is applied to the feed-side cleaning water, so that the pressure of the feed-side cleaning water is higher than the pressure of the discharge-side cleaning water. In the case of filtration under a reduced pressure, the cleaning water is sucked from the discharge side to draw the feed-side cleaning water. By adjusting the pressure difference between the feed-side cleaning water and the discharge-side cleaning water, the filtration speed can be controlled, obtaining a stable cleaning effect.

By slurry cleaning apparatus 10 of the present invention, the slurry and cleaning water can be efficiently contacted with each other in cleaning chamber 20. As a result, unnecessary components, such as a surfactant, an emulsifying agent, or a colorant added, for example, in the production process for a toner, or an excess resin which has not been incorporated into the toner matrix particles, can be efficiently removed.

As shown in FIGS. 1 and 4, slurry cleaning apparatus 10 comprises mainly three parts, i.e., upper member 30, intermediate member 32, and lower member 34.

Upper member 30 comprises a member in a substantially semicylindrical shape, and is a member constituting the wall portion of cleaning water storage chamber 26.

Intermediate member 32 comprises a substantially rectangular frame member having a top and a bottom which widely open. Intermediate member 32 is a member constituting the wall portion of cleaning chamber 20.

Lower member 34 comprises a member in a substantially semicylindrical shape which is substantially the same as the shape of upper member 30. Lower member 34 is a member constituting the wall portion of filtrate storage chamber 28.

Upper member 30, intermediate member 32, and lower member 34 are stacked in this order from the top to constitute slurry cleaning apparatus 10.

As shown in FIGS. 1 and 3, upper member 30, intermediate member 32, and lower member 34 are stacked and then, a plurality of ring bands 36 are wound round the resultant stacked member. Upper member 30, intermediate member 32, and lower member 34 in the state of being stacked in this order are firmly held by ring bands 36. Ring band 36 is comprised of, for example, a rubber or stainless steel in a band form.

As shown in FIG. 3, first filtration side 22 is disposed at the upper opening of intermediate member 32. First filtration side 22 comprises filter cloth 22a, and metal mesh member 22b arranged on the upper surface side of filter cloth 22a.

Second filtration side 24 is disposed at the lower opening of intermediate member 32. Second filtration side 24 comprises filter cloth 24a, and metal mesh member 24b arranged on the lower surface side of filter cloth 24a.

As filter cloths 22a, 24a, any filter cloth can be used as long as it can separate the toner matrix particles contained in the slurry. For example, a filter cloth made of a resin, such as nylon, polyester, or polypropylene, can be used. With respect to the size of the sieve opening of the filter cloth used, any size can be employed as long as it is a size such that the filter cloth can separate the toner matrix particles contained in the slurry and does not excessively inhibit penetration of the cleaning water.

As metal mesh members 22b, 24b, for example, a mesh member or a punching plate made of a metal, such as stainless steel, can be used. The form of filter cloth 22a is maintained by metal mesh member 22b arranged on the upper surface side of filter cloth 22a so that filter cloth 22a is prevented from being deflected due to the water pressure of the cleaning water. The form of filter cloth 24a is maintained by metal mesh member 24b arranged on the lower surface side of filter cloth 24a so that filter cloth 24a is prevented from being deflected due to the water pressure of the cleaning water.

As shown in FIGS. 3 and 4, the edge portion of filter cloth 22a constituting first filtration side 22 is sandwiched between the lower end of upper member 30 and the upper end of intermediate member 32. On the other hand, the edge portion of filter cloth 24a constituting second filtration side 24 is sandwiched between the upper end of lower member 34 and the lower end of intermediate member 32.

Convex portion 30a having a substantially semicircular cross-section is formed at the lower end of upper member 30. On the other hand, concave portion 32a having a substantially semicircular cross-section is formed at the upper end of intermediate member 32 in the position corresponding to convex portion 30a formed at upper member 30.

Convex portion 34a having a substantially semicircular cross-section is formed at the upper end of lower member 34. On the other hand, concave portion 32b having a substantially semicircular cross-section is formed at the lower end of intermediate member 32 in the position corresponding to convex portion 34a formed at lower member 34.

By combining upper member 30 with the upper portion of intermediate member 32, convex portion 30a formed at the lower end of upper member 30 is fitted to concave portion 32a formed at the upper end of intermediate member 32. Convex portion 30a is fitted to concave portion 32a, so that the edge portion of filter cloth 22a constituting first filtration side 22 is firmly held. The edge portion of filter cloth 22a is held, so that filter cloth 22a is prevented from being inwardly drawn due to the pressure of the cleaning water.

By combining lower member 34 with the lower portion of intermediate member 32, convex portion 34a formed at the upper end of lower member 34 is fitted to concave portion 32b formed at the lower end of intermediate member 32. Convex portion 34a is fitted to concave portion 32b, so that the edge portion of filter cloth 24a constituting second filtration side 24 is firmly held. The edge portion of filter cloth 24a is held, so that filter cloth 24a is prevented from being inwardly drawn due to the pressure of the cleaning water.

As shown in FIG. 1, in slurry cleaning apparatus 10 of the present invention, the direction of the slurry flowing in cleaning chamber 20 is perpendicular to the direction of the cleaning water flowing from first filtration side 22 toward second filtration side 24. In other words, the direction of the slurry flowing from slurry inlet 12 toward slurry outlet 14 is perpendicular to the direction of the cleaning water flowing from cleaning water inlet 16 toward cleaning water outlet 18. The direction of flow of the slurry is perpendicular to the direction of flow of the cleaning water, and therefore the slurry and the cleaning water are efficiently contacted with each other. As a result, unnecessary components contained in the slurry, such as a surfactant, can be efficiently removed in a short time.

In slurry cleaning apparatus 10 of the present invention, the slurry flowing in cleaning chamber 20 can be contacted with first filtration side 22 and second filtration side 24. The cleaning water stored in cleaning water storage chamber 26 passes through first filtration side 22 and flows into cleaning chamber 20. The cleaning water contacted with the slurry in cleaning chamber 20 is subjected to filtration by second filtration side 24. Thus, slurry cleaning apparatus 10 has first filtration side 22 and second filtration side 24 and therefore has a large filtration area. Accordingly, slurry cleaning apparatus 10 can efficiently remove unnecessary components contained in the slurry, such as a surfactant, in a short time.

An explanation was made on the example in which the cleaning water is fed from cleaning water inlet 16 located on the upper side and the cleaning water is discharged from cleaning water outlet 18 located on the lower side, but a construction such that the direction of the cleaning water is reversed can also be employed. That is, a construction can be employed in which the cleaning water is fed from cleaning water outlet 18 located on the lower side and the cleaning water is discharged from cleaning water inlet 16 located on the upper side. Switching the direction of flow of the cleaning water enables back wash for the filter cloth. Specifically, the toner matrix particles and others clogging filter cloth 24a of second filtration side 24 can be removed by back wash. By removing the toner matrix particles clogging filter cloth 24a, it is possible to prevent a lowering of the filtration speed for the slurry at second filtration side 24.

The filtration side through which the cleaning water passes when feeding the cleaning water to cleaning chamber 20 and the filtration side through which the cleaning water passes when filtering the slurry may be switched in the course of the cleaning. For example, by reversing the direction of flow of the cleaning water as mentioned above in the course of the cleaning of the slurry, the functions of first filtration side 22 and second filtration side 24 can be alternately switched.

The cleaning water and the slurry can also be simultaneously fed to cleaning chamber 20 through slurry inlet 12. In this case, the slurry can be subjected to filtration simultaneously using both first filtration side 22 and second filtration side 24. By subjecting the slurry to filtration simultaneously using both first filtration side 22 and second filtration side 24, not only can the filtration area be further increased, but also the filtration efficiency can be further improved.

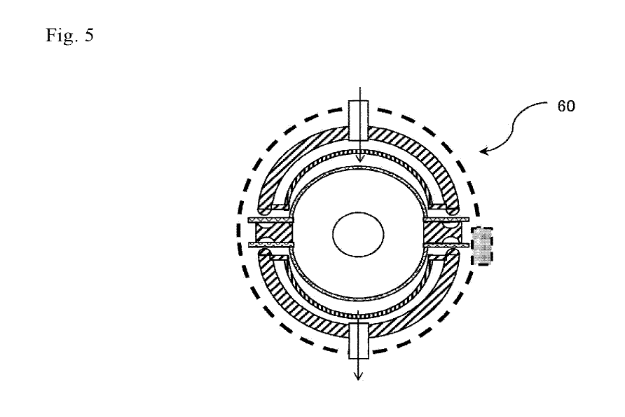

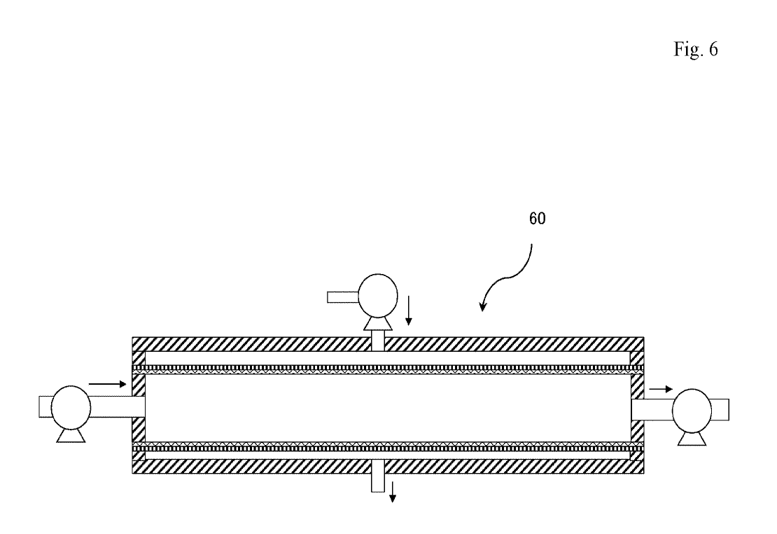

FIGS. 5 and 6 are cross-sectional views of slurry cleaning apparatus 60. Slurry cleaning apparatus 60 has substantially the same construction as that of the above-described slurry cleaning apparatus 10 except that the form of first filtration side 22 and second filtration side 24 is changed to a curved surface from the plane surface. When the form of the filtration side is changed to a curved surface, the form of the cross-section of cleaning chamber 20 is substantially circular. By changing the form of the filtration side to a curved surface, the effective filtration area can be increased, making it possible to improve the filtration efficiency.

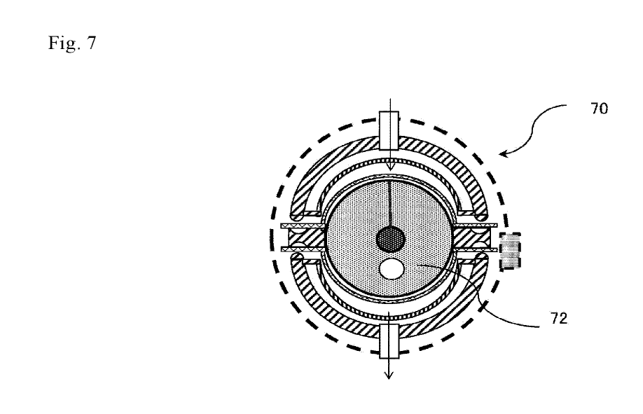

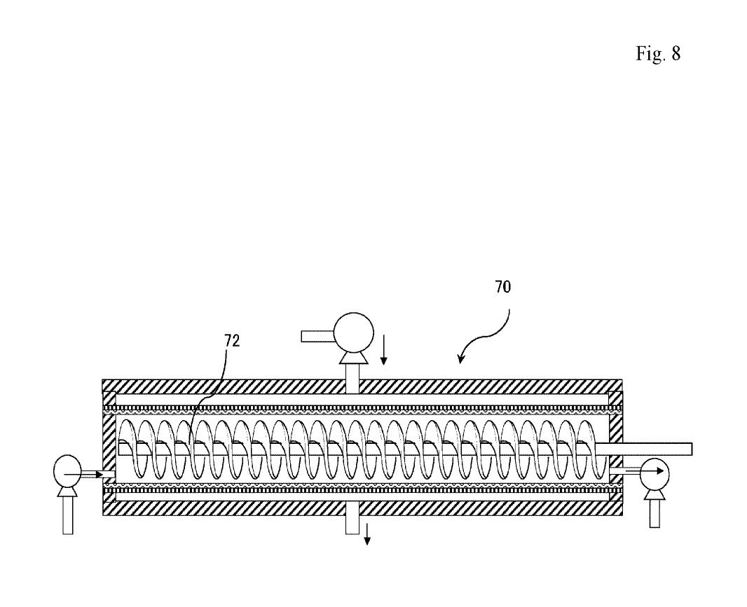

FIGS. 7 and 8 are cross-sectional views of slurry cleaning apparatus 70. Slurry cleaning apparatus 70 has substantially the same construction as that of the above-mentioned slurry cleaning apparatus 60 except that agitating blade 72 is disposed in the cleaning chamber. The form of the cross-section of the cleaning chamber is substantially circular. The toner deposited on the surface of the filter cloth can be stirred by the agitating blade disposed in the cleaning chamber. Solids, such as the toner deposited on the surface of the filter cloth, can be redispersed in water by agitating blade 72 disposed in the cleaning chamber. Further, not only can the filter cloth be prevented from suffering clogging, but also the cleaning efficiency for the slurry can be improved.

Solids, such as the toner deposited on the surface of the filter cloth, can be redispersed in water by agitating blade 72. With respect to the agitating blade, there is no particular limitation, but a screw-type agitating blade which is likely to be close to the filter cloth is preferred. When a screw-type agitating blade is used, a scraping effect occurs between the outer periphery edge of the screw and the filter cloth. By virtue of the scraping effect, the thickness of a deposit layer of solids, such as the toner, can be controlled. Further, by virtue of the scraping effect, not only can the filter cloth be prevented from suffering clogging, but also the filtration speed can be stably maintained.

The screw-type agitating blade can prevent the filter cloth from suffering clogging. As a result, the amount of the cleaning water used for the slurry can be increased, and therefore the cleaning efficiency can be improved.

By disposing a screw-type agitating blade in cleaning chamber 20, the path of movement of the slurry within cleaning chamber 20 is increased. As a result, the contact time of the slurry and the filtration side is increased, and therefore the filtration efficiency is improved. Further, scattering of the slurry can be prevented. Furthermore, the slurry can be cleaned more efficiently in a shorter time than a cleaning method in a batch-wise manner.

In addition, slurry cleaning apparatus 70 functions as a screw conveyer which can transfer the slurry. Therefore, while transferring the slurry, the slurry can be efficiently cleaned.

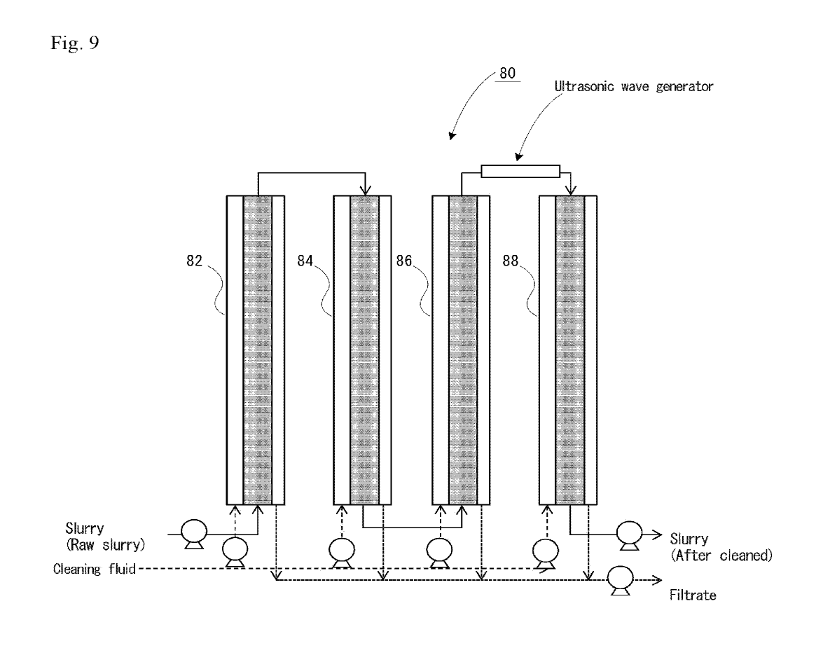

FIG. 9 shows an example of the construction of system 100 comprising a plurality (4) of slurry cleaning apparatuses 10 which are connected in series.

As shown in FIG. 9, system 80 comprises first cleaning apparatus 82, second cleaning apparatus 84, third cleaning apparatus 86, and fourth cleaning apparatus 88. First to fourth cleaning apparatuses 82, 84, 86, 88 individually have the same construction as that of the above-described slurry cleaning apparatus 10.

The slurry outlet of first cleaning apparatus 82 is connected to the slurry inlet of second cleaning apparatus 84. The slurry outlet of second cleaning apparatus 84 is connected to the slurry inlet of third cleaning apparatus 86. The slurry outlet of third cleaning apparatus 86 is connected to the slurry inlet of fourth cleaning apparatus 88. Therefore, the slurry fed through the slurry inlet of first cleaning apparatus 82 is cleaned by first cleaning apparatus 82, second cleaning apparatus 84, third cleaning apparatus 86, and fourth cleaning apparatus 88, and then discharged through the slurry outlet of fourth cleaning apparatus 88.

By using a plurality of slurry cleaning apparatuses 10 which are connected in series, unnecessary components contained in the slurry, such as a surfactant, can be efficiently removed in a shorter time.

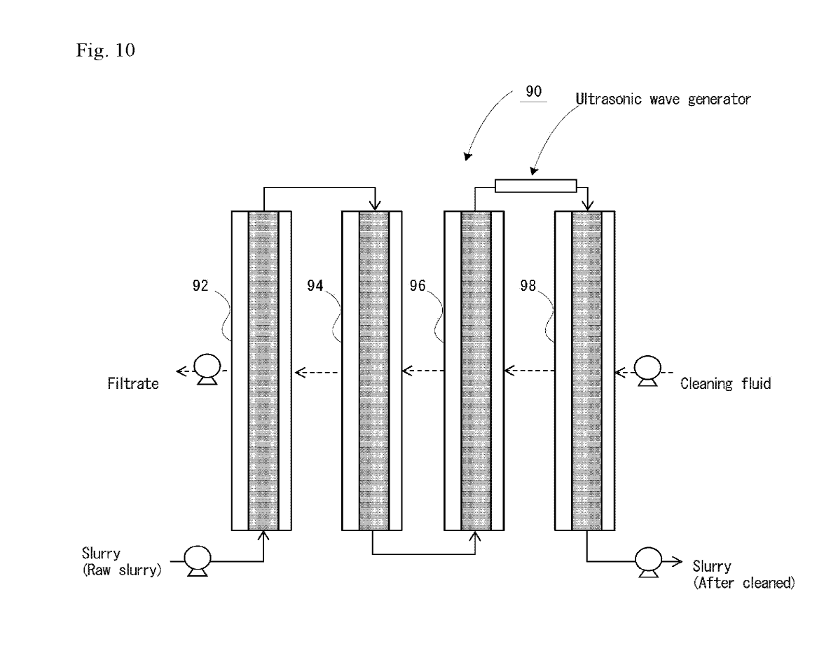

FIG. 10 shows an example of the construction of system 90 comprising a plurality (4) of slurry cleaning apparatuses 10 which are connected in series.

As shown in FIG. 10, like system 80, system 90 comprises first cleaning apparatus 92, second cleaning apparatus 94, third cleaning apparatus 96, and fourth cleaning apparatus 98. First to fourth cleaning apparatuses 92, 94, 96, 98 individually have the same construction as that of the above-described slurry cleaning apparatus 10. The piping for first to fourth cleaning apparatuses 92, 94, 96, 98 constituting system 90 is connected in substantially the same manner as in system 80 except the piping for the cleaning water.

With respect to the connection of the piping for flowing the cleaning water and filtrate, in the case of system 90, the direction of flow of the cleaning water and the direction of flow of the slurry are opposite. The cleaning water outlet of fourth cleaning apparatus 98 is connected to the cleaning water inlet of third cleaning apparatus 96. The cleaning water outlet of third cleaning apparatus 96 is connected to the cleaning water inlet of second cleaning apparatus 94. The cleaning water outlet of second cleaning apparatus 94 is connected to the cleaning water inlet of first cleaning apparatus 92. Therefore, the cleaning water fed through the cleaning water inlet of fourth cleaning apparatus 98 is mixed with the slurry and subjected to filtration in fourth cleaning apparatus 98, third cleaning apparatus 96, second cleaning apparatus 94, and first cleaning apparatus 92, and then discharged as a filtrate through the cleaning water outlet of first cleaning apparatus 92. When the direction of flow of the slurry and the direction of flow of the cleaning water are opposite as mentioned above, the slurry can be cleaned with the cleaning water in a further reduced amount.

Using slurry cleaning apparatus 60 or slurry cleaning apparatus 70 instead of slurry cleaning apparatus 10, the same cleaning system as system 80 or system 90 can be established.

Further, for more quickly removing impurities, such as an emulsifying agent adhering to the surface of the core particles, if necessary, an ultrasonic wave generator or a temperature controller can be employed. The ultrasonic wave generator or temperature controller can be located in slurry cleaning apparatus 10, slurry cleaning apparatus 60, or slurry cleaning apparatus 70. The ultrasonic wave generator or temperature controller can also be located in the circuit between the slurry cleaning apparatuses through which the slurry flows.

The ultrasonic wave generator can be located in a cleaning system comprising a plurality of the slurry cleaning apparatuses. It is preferred that the ultrasonic wave generator is located in a position which is present in the latter half of the cleaning system and before the slurry cleaning apparatus at the end. When the ultrasonic wave generator is located in the first half of the cleaning system, a large amount of impurities remaining in the slurry, together with the toner, make it difficult to obtain the cleaning effect of ultrasonic waves for the surface of the toner. When the ultrasonic wave generator is located after the slurry cleaning apparatus at the end, impurities, such as an emulsifying agent removed by ultrasonic waves from the surface of the toner, are mixed into the slurry, leading to a danger that the subsequent steps are adversely affected. By introducing the ultrasonic wave generator, not only an improvement of the cleaning efficiency for the toner but also an effect of redispersing flocculate of the toner particles caused during the cleaning can be expected.

The temperature controller can be located in the slurry cleaning apparatus, the circuit between the apparatuses through which the slurry flows, or the circuit through which the cleaning water flows. The temperature of the slurry controlled by the temperature controller is preferably set to be a temperature lower than the glass transition point and melting point of the resin component constituting the toner particles. When the temperature of the slurry is set to be higher than the glass transition point and melting point of the resin component, there is a danger that flocculate of the toner particles is caused during the cleaning.

The temperature control upon cleaning the slurry can also be achieved by controlling the temperature of the cleaning water used. Even in such a case, for the same reason as mentioned above, the temperature of the cleaning water is preferably set to be a temperature lower than the glass transition point and melting point of the resin component constituting the toner particles.

The ultrasonic wave generator and the temperature controller can be simultaneously used, and can also be individually or separately used. By subjecting the slurry containing the toner particles to ultrasonic treatment or controlling the temperature of the slurry, it is possible to more efficiently remove impurities adhering to the surface of the toner particles. As a result, not only can the cleaning efficiency for the toner particles be improved, but also the toner particles can be cleaned in a short time.

Slurry cleaning apparatuses 10, 60, 70 of the present invention can be especially preferably used in producing the toner matrix particles having a core/shell structure. Particularly, slurry cleaning apparatuses 10, 60, 70 of the present invention can be preferably applied to the cleaning step for the slurry containing core particles or shell particles, which is required to strictly control the charge state of the surface of the particles.

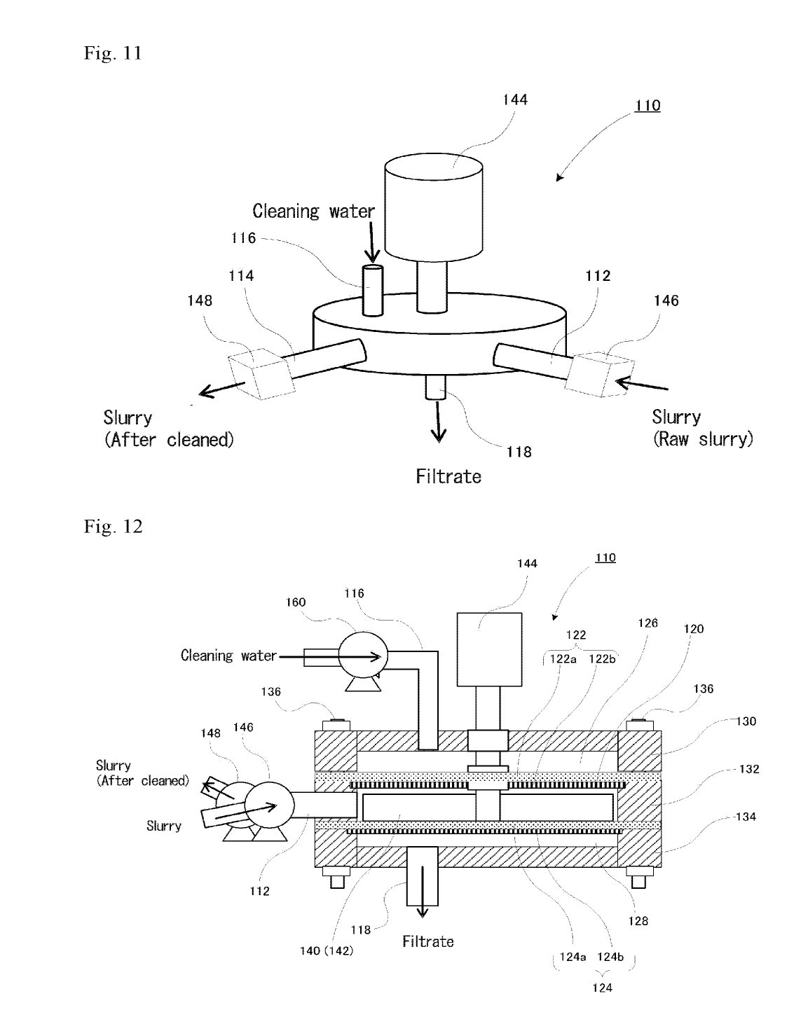

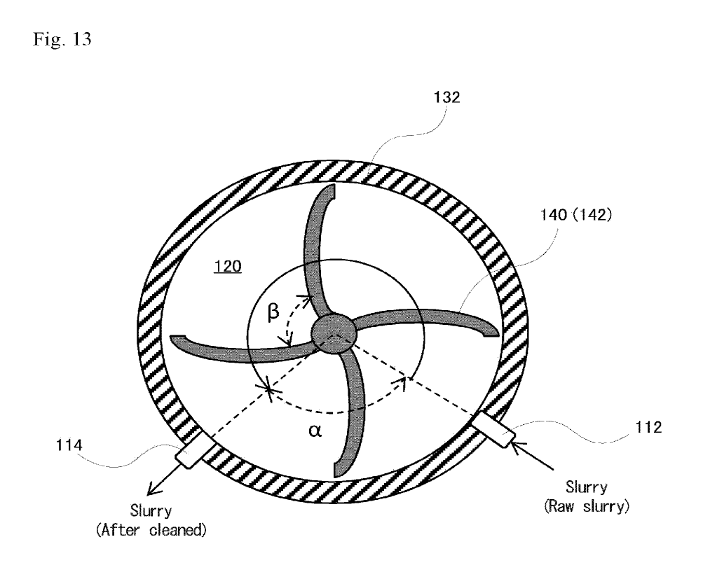

FIG. 11 is a perspective view of the slurry cleaning apparatus. FIG. 12 is a sectional side view of the slurry cleaning apparatus. FIG. 13 is a sectional top view of the slurry cleaning apparatus.

As shown in FIG. 11, slurry cleaning apparatus 110 of the present invention has slurry inlet 112 through which a slurry is fed, slurry feed device 146 for feeding the slurry quantitatively (at a constant flow rate), slurry outlet 114 through which the slurry is discharged, slurry discharge device 148 for controlling the amount of the slurry discharged, cleaning water inlet 116 through which cleaning water is fed, and cleaning water outlet 118 through which the cleaning water is discharged.

As shown in FIG. 12, slurry cleaning apparatus 110 has cleaning chamber 120 for contacting a slurry with cleaning water. By contacting the slurry with the cleaning water, unnecessary components contained in the slurry, such as a surfactant, can be removed.

Cleaning chamber 120 has first filtration side 122 and second filtration side 124 each having water permeability. First filtration side 122 is disposed on the upper side of cleaning chamber 120, and second filtration side 124 is disposed on the lower side of cleaning chamber 120. First filtration side 122 and second filtration side 124 are arranged in substantially parallel with each other. The slurry is quantitatively fed from slurry inlet 12 to cleaning chamber 120 through slurry feed device 146. The slurry fed to cleaning chamber 120 flows in a space in contact with first filtration side 122 and second filtration side 124, and then is discharged from slurry outlet 114. The slurry is quantitatively discharged to the outside through slurry discharge device 148.

Slurry feed device 146 and slurry discharge device 148 are a device that can control the flow rate of the slurry. Slurry feed device 146 and slurry discharge device 148 individually comprise, for example, a constant delivery pump, a flow rate controller, or a pressure regulating valve. By controlling the flow rate of the slurry using slurry feed device 146 and slurry discharge device 148, it is possible to adjust the concentration of the cleaned slurry.

Cleaning water storage chamber 126 is provided above cleaning chamber 120 through first filtration side 122. On the other hand, filtrate storage chamber 128 is provided below cleaning chamber 120 through second filtration side 124.

The cleaning water is fed through cleaning water inlet 116. Cleaning water feed device 160 for feeding the cleaning water to cleaning chamber 120 at a constant flow rate is located at cleaning water inlet 116. From the viewpoint of facilitating the control of the cleaning water flow rate, cleaning water feed device 160 preferably comprises a flow rate controller, such as a constant delivery pump or a flow rate valve. The flow rate of the slurry and the concentration of the slurry in cleaning chamber 120 can be controlled by the flow rate of the cleaning water fed by cleaning water feed device 160.

The cleaning water fed through cleaning water inlet 116 is once stored in cleaning water storage chamber 126, and then passes through first filtration side 122 and flows into cleaning chamber 120. The cleaning water in cleaning chamber 120 is brought into contact with the slurry in cleaning chamber 120, and then passes through second filtration side 124 and flows into filtrate storage chamber 128. The cleaning water (filtrate) in filtrate storage chamber 128 is discharged to the outside through cleaning water outlet 118.

The filtration method may be either pressure filtration or filtration under a reduced pressure. In the case of pressure filtration, the cleaning water is fed under a pressure higher than the discharge-side pressure. In the case of filtration under a reduced pressure, the cleaning water is sucked from the discharge side under a negative pressure to draw the feed-side cleaning water. By adjusting the pressure difference between the feed-side cleaning water and the discharge-side cleaning water, the filtration speed can be controlled. Further, by controlling the flow rate of the slurry and the flow rate of the cleaning water simultaneously, the cleaning efficiency can be precisely controlled. By precisely controlling the cleaning efficiency, a stable cleaning effect can be obtained.

By slurry cleaning apparatus 110 of the present invention, the slurry and cleaning water can be efficiently contacted with each other in cleaning chamber 120. As a result, unnecessary components, such as a surfactant, an emulsifying agent, or a colorant added, for example, in the production process for a toner, or the unreacted monomer which has not been used for forming the toner, can be efficiently removed from the slurry.

As shown in FIG. 12, slurry cleaning apparatus 110 comprises mainly three parts, i.e., upper member 130, intermediate member 132, and lower member 134.

Upper member 130 comprises a member in a substantially cylindrical shape. Upper member 130 is a member constituting the wall portion of cleaning water storage chamber 126.

Intermediate member 132 comprises a member in a substantially cylindrical shape having a top and a bottom which open. Intermediate member 132 is a member constituting the wall portion of cleaning chamber 120.

Lower member 134 comprises a member in a substantially cylindrical shape which is substantially the same as the shape of upper member 130. Lower member 134 is a member constituting the wall portion of filtrate storage chamber 128.

Upper member 130, intermediate member 132, and lower member 134 are stacked in this order from the top. Upper member 130, intermediate member 132, and lower member 134 constitute slurry cleaning apparatus 110. Upper member 130, intermediate member 132, and lower member 134 are connected in the vertical direction by a plurality of bolts 136.

As shown in FIG. 12, first filtration side 122 is disposed at the upper opening of intermediate member 132. First filtration side 122 comprises filter cloth 122a, and support member 122b arranged on the lower surface side of filter cloth 122a.

Second filtration side 124 is disposed at the lower opening of intermediate member 132. Second filtration side 124 comprises filter cloth 124a, and support member 124b arranged on the lower surface side of filter cloth 124a.

As filter cloths 122a, 124a, any filter cloth can be used as long as it can separate the toner matrix particles or resin fine particles contained in the slurry. For example, a filter cloth made of a resin, such as nylon, polyester, or polypropylene, can be used. With respect to the size of the sieve opening of the filter cloth used, any size can be employed as long as it is a size such that the filter cloth can separate the toner matrix particles or resin fine particles contained in the slurry and does not excessively inhibit penetration of the cleaning water.

As support members 122b, 124b, any member can be used as long as it is a member having such stiffness that the member can support filter cloths 122a, 124a. As support members 122b, 124b, for example, a mesh member or a punching plate made of a metal, such as stainless steel, can be used. The form of filter cloth 122a is maintained by support member 122b arranged on the lower surface side of filter cloth 122a. Further, support member 122b prevents filter cloth 122a from being downwardly deflected due to the pressure of the cleaning water. The form of filter cloth 124a is maintained by support member 124b arranged on the lower surface side of filter cloth 124a. Further, support member 124b prevents filter cloth 24a from being downwardly deflected due to the pressure of the cleaning water.

As shown in FIG. 12, the edge portion of filter cloth 122a constituting first filtration side 122 is sandwiched between the lower end of upper member 130 and the upper end of intermediate member 132. Thus, filter cloth 122a is fixed so as not to move. Further, the edge portion of filter cloth 124a constituting second filtration side 124 is sandwiched between the upper end of lower member 134 and the lower end of intermediate member 132. Thus, filter cloth 124a is fixed so as not to move.

As shown in FIG. 13, delivery means 140 is disposed inside of cleaning chamber 120 which is formed in a substantially cylindrical shape. Delivery means 140 is a means for sending the slurry fed from slurry inlet 112 toward slurry outlet 114.

In the present embodiment, delivery means 140 comprises rotatable blade member 142 having four blades. Blade member 142 is formed from, for example, a hard synthetic resin or a metal, such as stainless steel. As blade member 142, for example, an agitating blade can be used. Blade member 142 is constructed so that the two adjacent blades have an angle of 90 degrees. The number of the blades of blade member 142 is not limited to 4, and may be, for example, 3 or less, and may be 5 or more.

As shown in FIG. 13, cleaning chamber 120 formed in a substantially cylindrical shape is provided with slurry inlet 112 and slurry outlet 114. Slurry inlet 112 and slurry outlet 114 are formed in the outer periphery portion of cleaning chamber 120 at different positions in the circumferential direction. Slurry inlet 112 and slurry outlet 114 are formed at respective positions about 90 degrees or more in the circumferential direction far away from each other.

As shown in FIG. 13, the line connecting slurry inlet 112 and the center of cleaning chamber 120 and the line connecting slurry outlet 114 and the center of cleaning chamber 120 have angle α. The two adjacent blades of blade member 42 have angle β. It is preferred that angle α is smaller than 180 degrees and equal to or larger than angle β. The reason for this resides in that when angle α is equal to angle β or larger than angle β, the slurry fed through slurry inlet 112 is prevented from mixing with the slurry discharged through slurry outlet 114. In the present embodiment, angle α is 90 degrees or more and angle β is 90 degrees, and therefore the above-mentioned effects are obtained.

It is preferred that the height of blade member 142 is substantially the same as the height of cleaning chamber 120 (for example, 80% or more of the height of cleaning chamber 120). When the height of blade member 142 is substantially the same as the height of cleaning chamber 120, the gap between blade member 142 and the filtration side can be narrowed. By narrowing the gap between blade member 142 and the filtration side, it is possible to prevent the slurry present between the two adjacent blades of blade member 142 from mixing or scattering into a space between the other two adjacent blades. As a result, the cleaning efficiency can be improved.

As shown in FIGS. 11 and 12, rotation means 144 for rotating blade member 142 disposed in cleaning chamber 120 is located further above upper member 130. Rotation means 144 comprises, for example, an electric motor. Rotation means 144 makes it possible to rotate blade member 142 in an arbitrary direction of rotation at an arbitrary rotational speed.

As shown in FIG. 12, slurry cleaning apparatus 110 of the present invention comprises slurry feed device 146 for feeding a slurry, slurry discharge device 148 for discharging the slurry, and cleaning water feed device 160 for feeding cleaning water.

Slurry feed device 146 and slurry discharge device 148 are a device that can control the flow rate of the slurry. Slurry feed device 146 and slurry discharge device 148 individually comprise, for example, a constant delivery pump, a flow rate controller, and/or a pressure regulating valve.

The flow rate of the slurry can be controlled by slurry feed device 146 and slurry discharge device 148. By controlling the flow rate of the slurry, it is possible to adjust the concentration of the cleaned slurry.

Cleaning water feed device 160 is a device that can control the flow rate of the cleaning water. Cleaning water feed device 160 comprises, for example, a constant delivery pump, a flow rate controller, and/or a pressure regulating valve.

The flow rate of the cleaning water can be controlled by cleaning water feed device 160. By controlling the flow rate of the cleaning water, it is possible to control the filtration efficiency and cleaning efficiency.

As shown in FIG. 13, in slurry cleaning apparatus 110 of the present invention, the direction of rotation of blade member 142 is consistent with the direction of flow of the slurry. Specifically, in FIG. 13, when blade member 142 rotates in an anticlockwise direction, the slurry flows anticlockwise. When blade member 142 rotates in a clockwise direction, the slurry flows clockwise.

The direction of rotation of slurry or blade member 142 is preferably a direction such that the distance of from slurry inlet 112 to slurry outlet 114 along the outer periphery portion of cleaning chamber 120 formed in a substantially cylindrical shape is maximum. In this case, the slurry fed through slurry inlet 112 is moved by the rotation of blade member. In cleaning chamber 120 formed in a substantially cylindrical shape, the distance of movement of the slurry is maximum. When the distance of movement of the slurry is maximum, the cleaning efficiency is further improved.

In FIG. 12, the cleaning water flows in the direction of from first filtration side 122 toward second filtration side 124. That is, the cleaning water flows in cleaning chamber 120 in the direction from the top to the bottom. Further, in FIG. 13, the cleaning water flows in the direction perpendicular to the plane of paper.

Accordingly, the slurry rotates in cleaning chamber 120 and meanwhile, the cleaning water flows down in the direction perpendicular to the plane of rotation of the slurry. As a result, the slurry and cleaning water can be extremely efficiently contacted with each other. Further, unnecessary components contained in the slurry, such as a surfactant, can be efficiently removed in a short time.

In slurry cleaning apparatus 110 of the present invention, the slurry flowing in cleaning chamber 120 can be contacted with first filtration side 122 and second filtration side 124. The cleaning water stored in cleaning water storage chamber 126 passes through first filtration side 122 and flows into cleaning chamber 120. The cleaning water contacted with the slurry in cleaning chamber 120 is subjected to filtration by second filtration side 124, and then discharged through cleaning water outlet 118. Therefore, a large filtration area is secured by first filtration side 122 and second filtration side 124. As a result, unnecessary components contained in the slurry, such as a surfactant, can be efficiently removed in a short time.

In slurry cleaning apparatus 110 of the present invention, the slurry is continuously moved by blade member 142, and therefore it is possible to prevent the toner matrix particles from being deposited on second filtration side 124 to form a layer having a non-uniform thickness. Thus, second filtration side 124 can be prevented from being clogged with the toner matrix particles. As a result, the slurry can be continuously and stably cleaned.

In the above embodiment, an explanation was made on the example in which the cleaning water is fed from cleaning water inlet 116 located on the upper side and the cleaning water is discharged from cleaning water outlet 118 located on the lower side, but a construction such that the direction of the cleaning water is reversed can also be employed. That is, a construction can be employed in which the cleaning water is fed from cleaning water outlet 118 located on the lower side and the cleaning water is discharged from cleaning water inlet 116 located on the upper side. In this case, the toner matrix particles clogging filter cloth 124a of second filtration side 124 can be removed by back wash. Further, it is possible to prevent second filtration side 124 from being clogged with the toner matrix particles to lower the cleaning speed for the slurry.

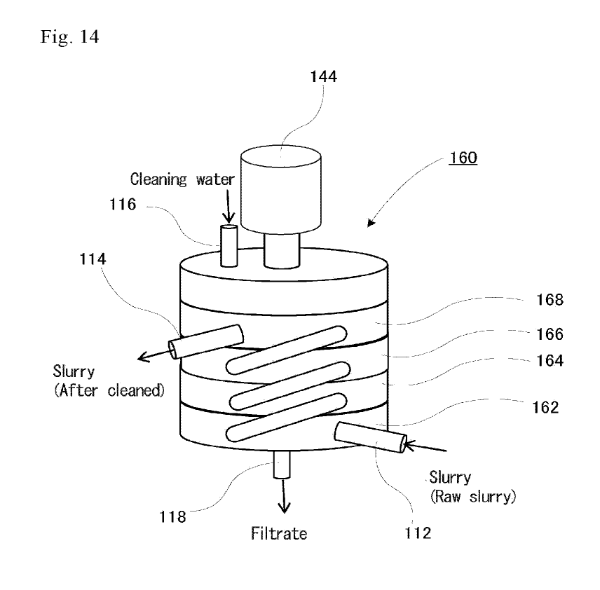

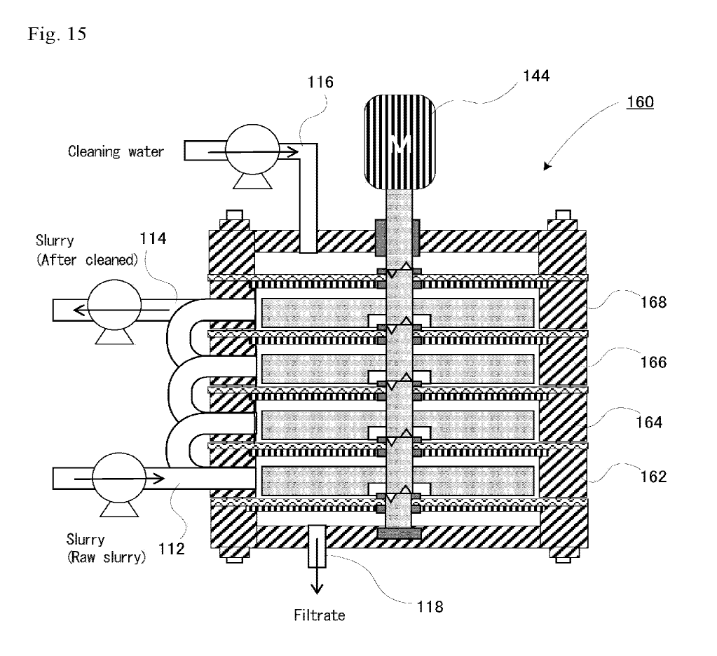

FIG. 14 is a perspective view showing an example of the construction of stacking-type slurry cleaning apparatus 160. FIG. 15 is a cross-sectional view of stacking-type slurry cleaning apparatus 160.

Slurry cleaning apparatus 160 comprises a plurality of cleaning apparatuses connected in series. The cleaning apparatuses are stacked in the vertical direction on one another.

As shown in FIGS. 14 and 15, stacking-type slurry cleaning apparatus 160 comprises first cleaning apparatus 162, second cleaning apparatus 164, third cleaning apparatus 166, and fourth cleaning apparatus 168. First to fourth cleaning apparatuses 162, 164, 166, 168 individually have the same construction as that of the above-described slurry cleaning apparatus 10.

The slurry outlet of first cleaning apparatus 162 is connected to the slurry inlet of second cleaning apparatus 164. The slurry outlet of second cleaning apparatus 164 is connected to the slurry inlet of third cleaning apparatus 166. The slurry outlet of third cleaning apparatus 166 is connected to the slurry inlet of fourth cleaning apparatus 168. Therefore, the slurry fed through slurry inlet 112 of first cleaning apparatus 162 is cleaned by first cleaning apparatus 162, second cleaning apparatus 164, third cleaning apparatus 166, and fourth cleaning apparatus 168, and then discharged through slurry outlet 114 of fourth cleaning apparatus 168.

In stacking-type slurry cleaning apparatus 160, the direction of flow of the cleaning water and the direction of flow of the slurry are opposite. That is, the cleaning water flows in the direction from the top to the bottom and meanwhile, the slurry flows in the direction from the bottom to the top.

By using a plurality of slurry cleaning apparatuses 110 which are connected in series, unnecessary components contained in the slurry, such as a surfactant, can be efficiently removed in a shorter time. Further, countercurrent contact of the cleaning water flowing downwardly and the slurry flowing upwardly can be made. The cleaning efficiency for the slurry can be further improved by countercurrent contact of the cleaning water and the slurry. The amount of the cleaning water used can also be reduced. Further, by connecting a plurality of slurry cleaning apparatuses 110 by stacking them on one another, the space required for installation of stacking-type slurry cleaning apparatus 160 can be reduced.

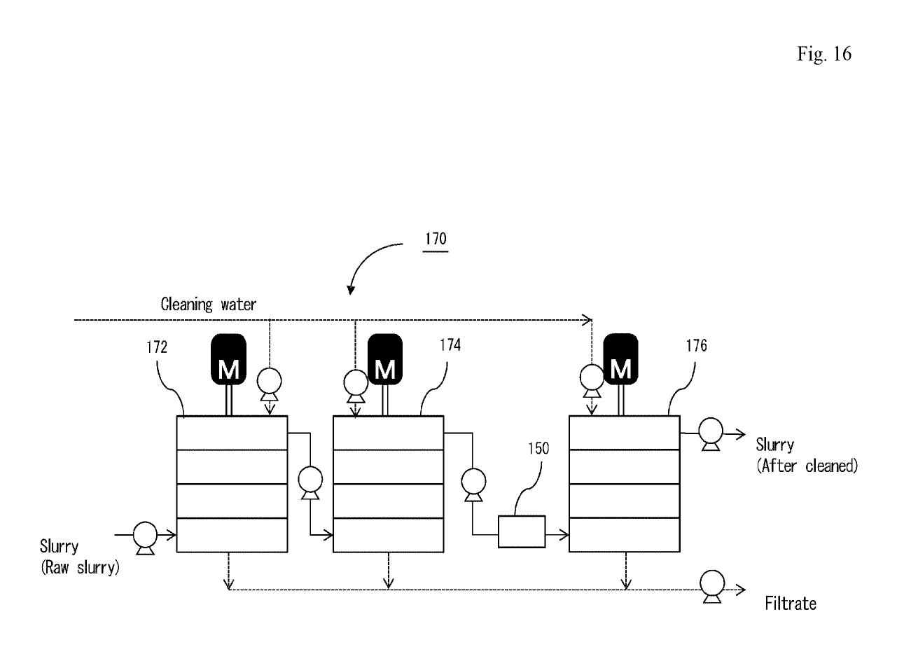

FIG. 16 shows an example of the construction of system 170 comprising a plurality (3) of slurry cleaning apparatuses or stacking-type slurry cleaning apparatuses. In system 170, the apparatuses are connected in series.

As shown in FIG. 16, system 170 comprises first cleaning apparatus 172, second cleaning apparatus 174, and third cleaning apparatus 176. First to third cleaning apparatuses 172, 174, 176 individually have the same construction as that of the above-described slurry cleaning apparatus 110 or stacking-type slurry cleaning apparatus 160.

The slurry outlet of first cleaning apparatus 172 is connected to the slurry inlet of second cleaning apparatus 174. The slurry outlet of second cleaning apparatus 174 is connected to the slurry inlet of third cleaning apparatus 176. Therefore, the slurry fed through the slurry inlet of first cleaning apparatus 172 is cleaned by first cleaning apparatus 172, second cleaning apparatus 174, and third cleaning apparatus 176, and then discharged through the slurry outlet of third cleaning apparatus 176.

The cleaning water is fed through the cleaning water inlet formed in each cleaning apparatus. In each cleaning apparatus, the cleaning water and the slurry are mixed with each other, and then the cleaning water is subjected to filtration. The cleaning water subjected to filtration is discharged through the cleaning water outlet formed in each cleaning apparatus.

By using a plurality of slurry cleaning apparatuses 110 which are connected in series, unnecessary components contained in the slurry, such as a surfactant, can be efficiently removed in a shorter time.

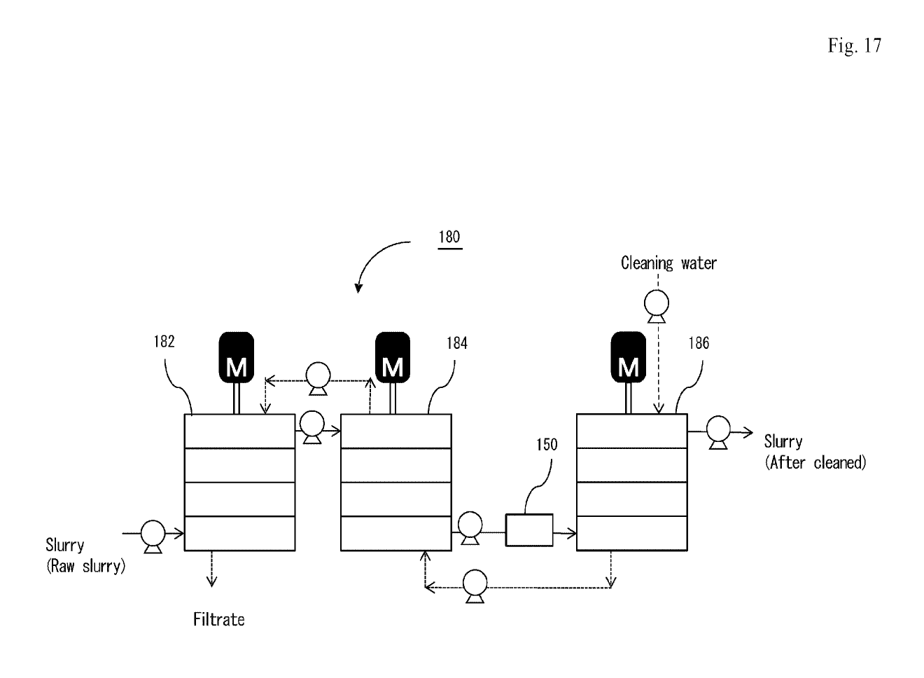

FIG. 17 shows an example of the construction of system 180 comprising a plurality (3) of slurry cleaning apparatuses or stacking-type slurry cleaning apparatuses. In system 180, the apparatuses are connected in series.

As shown in FIG. 17, system 180 comprises first cleaning apparatus 182, second cleaning apparatus 184, and third cleaning apparatus 186. First to third cleaning apparatuses 182, 184, 186 individually have the same construction as that of the above-described slurry cleaning apparatus 110 or stacking-type slurry cleaning apparatus 160.

The slurry outlet of first cleaning apparatus 182 is connected to the slurry inlet of second cleaning apparatus 184. The slurry outlet of second cleaning apparatus 184 is connected to the slurry inlet of third cleaning apparatus 186. Therefore, the slurry fed through the slurry inlet of first cleaning apparatus 182 is cleaned by first cleaning apparatus 182, second cleaning apparatus 184, and third cleaning apparatus 186, and then discharged through the slurry outlet of third cleaning apparatus 186.

The direction of flow of the cleaning water and the direction of flow of the slurry are opposite. The cleaning water outlet of third cleaning apparatus 186 is connected to the cleaning water inlet of second cleaning apparatus 184. The cleaning water outlet of second cleaning apparatus 184 is connected to the cleaning water inlet of first cleaning apparatus 182. Therefore, the cleaning water fed through the cleaning water inlet of third cleaning apparatus 186 is mixed with the slurry and subjected to filtration by third cleaning apparatus 186, second cleaning apparatus 184, and first cleaning apparatus 182, and then discharged through the cleaning water outlet of first cleaning apparatus 182.

By using a plurality of the slurry cleaning apparatuses or stacking-type slurry cleaning apparatuses which are connected in series, unnecessary components contained in the slurry, such as a surfactant, can be efficiently removed in a shorter time.

Using the above-mentioned slurry cleaning apparatus 110, stacking-type slurry cleaning apparatus 160, system 170, or system 180, the slurry can be cleaned. The cleaning method for the slurry may be of a continuous manner in which the slurry is passed through once the individual cleaning apparatuses. The cleaning method for the slurry may be of a batch-wise manner in which the slurry is passed through each cleaning apparatus two or more times via a circulation circuit. From the viewpoint of the productivity, the cleaning method for the slurry is preferably of a continuous manner.

For more quickly removing impurities, such as an emulsifying agent adhering to the surface of the core particles, an ultrasonic wave generator or a temperature controller may be used. The ultrasonic wave generator or temperature controller can be located in the circuit in slurry cleaning apparatus 110, stacking-type slurry cleaning apparatus 160, system 170, or system 180, through which the slurry flows.

The ultrasonic wave generator can be located in a cleaning system comprising a plurality of the slurry cleaning apparatuses. It is preferred that the ultrasonic wave generator is located in a position which is present in the latter half of the cleaning system and before the slurry cleaning apparatus at the end. When the ultrasonic wave generator is located in the first half of the cleaning system, a large amount of impurities remaining in the slurry, together with the toner, make it difficult to obtain the cleaning effect of ultrasonic waves for the surface of the toner. When the ultrasonic wave generator is located after the slurry cleaning apparatus at the end, impurities, such as an emulsifying agent removed by ultrasonic waves from the surface of the toner, are mixed into the slurry, leading to a danger that the subsequent steps are adversely affected. By introducing the ultrasonic wave generator, not only an improvement of the cleaning efficiency for the toner but also an effect of redispersing flocculate of the toner particles caused during the cleaning can be expected.

The temperature controller can be located in the slurry cleaning apparatus, the circuit between the apparatuses through which the slurry flows, or the circuit through which the cleaning water flows. The temperature of the slurry controlled by the temperature controller is preferably set to be a temperature lower than the glass transition point and melting point of the resin component constituting the toner particles. When the temperature of the slurry is set to be higher than the glass transition point and melting point of the resin component, there is a danger that flocculate of the toner particles is caused during the cleaning.

The temperature control upon cleaning the slurry can also be achieved by controlling the temperature of the cleaning water used. Even in such a case, for the same reason as mentioned above, the temperature of the cleaning water is preferably set to be a temperature lower than the glass transition point and melting point of the resin component constituting the toner particles.

The ultrasonic wave generator and the temperature controller can be simultaneously used, and can also be individually or separately used. By subjecting the slurry containing the toner particles to ultrasonic treatment or controlling the temperature of the slurry, it is possible to more efficiently remove impurities adhering to the surface of the toner particles. As a result, not only can the cleaning efficiency for the toner particles be improved, but also the toner particles can be cleaned in a short time.

Slurry cleaning apparatus 110, stacking-type slurry cleaning apparatus 160, system 170, or system 180 of the present invention can be especially preferably used in producing the toner matrix particles having a core/shell structure. Particularly, slurry cleaning apparatus 110, stacking-type slurry cleaning apparatus 160, system 170, or system 180 of the present invention can be preferably applied to the cleaning step for the slurry containing core particles or shell particles, which is required to strictly control the charge state of the surface of the particles.

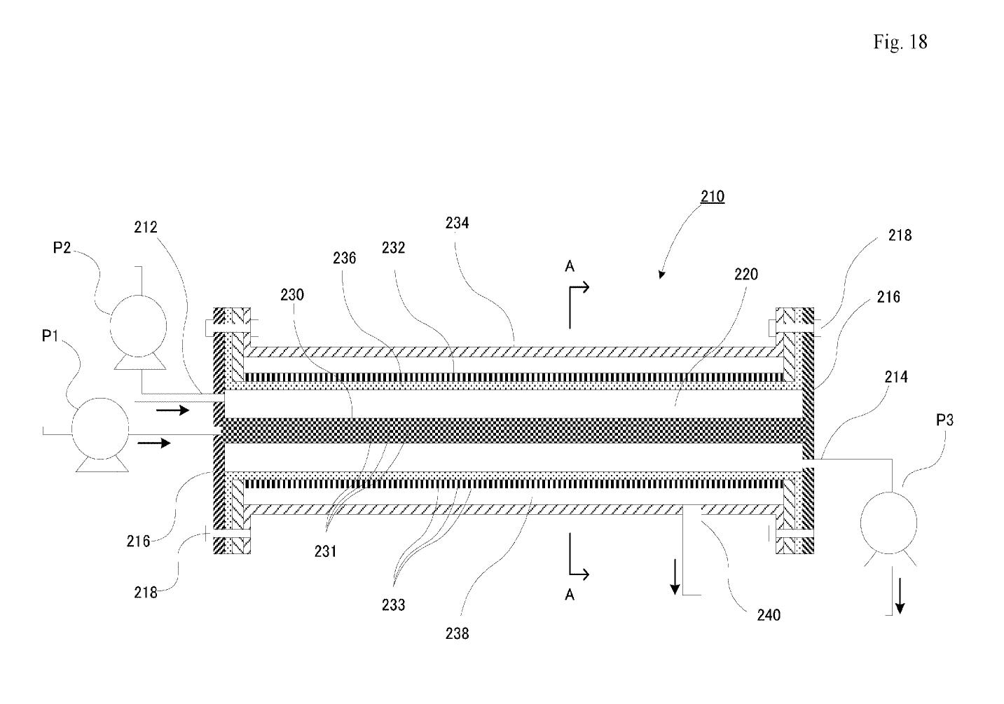

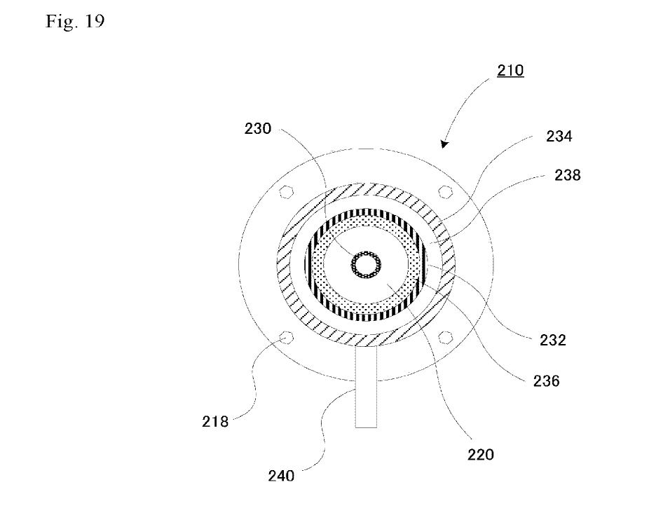

FIG. 18 is a cross-sectional view of the slurry cleaning apparatus. FIG. 19 is a cross-sectional view of the slurry cleaning apparatus shown in FIG. 18, taken along line A-A.

As shown in FIGS. 18 and 19, slurry cleaning apparatus 210 has cleaning chamber 220. Cleaning chamber 220 is a space in which a slurry and cleaning water are contacted with each other to clean the slurry. By cleaning the slurry, excess components contained in the slurry, such as a surfactant, can be removed.

Slurry cleaning apparatus 210 has slurry inlet 212, slurry feed device P2, slurry outlet 214, and slurry discharge device P3. Slurry inlet 212 is an inlet through which a slurry is fed to cleaning chamber 220. Slurry feed device P2 is a device for feeding the slurry quantitatively (at a constant flow rate). Slurry outlet 214 is an outlet through which the cleaned slurry is discharged from cleaning chamber 220. Slurry discharge device P3 is a device for controlling the amount of the slurry discharged.

Slurry cleaning apparatus 210 has water supply cylinder 230 in a substantially cylindrical shape, inner cylinder member 232, and outer cylinder member 234. Inner cylinder member 232 is disposed inside of outer cylinder member 234. Water supply cylinder 230 is disposed inside of inner cylinder member 232. That is, three members of water supply cylinder 230, inner cylinder member 232, and outer cylinder member 234 are combined so that the single center axis is common to the all members to constitute a triple cylinder.

Flange 216 is fitted by bolt 218 to each of the both ends of the thus combined water supply cylinder 230, inner cylinder member 232, and outer cylinder member 234. As a result, cleaning chamber 220, which is a space in which the slurry and the cleaning water are contacted with each other, is formed between water supply cylinder 230 and inner cylinder member 232. Further, filtrate storage chamber 238 for storing the cleaning water (filtrate) which has been subjected to filtration by filtration member 236 is formed between inner cylinder member 232 and outer cylinder member 234. Filtration member 236 is fitted to the inner side of inner cylinder member 232.

With respect to water supply cylinder 230, inner cylinder member 232, and outer cylinder member 234, there is no particular limitation, but they are formed from, for example, a metal material, such as stainless steel.

A plurality of water spray pores 231 are formed in the outer periphery surface of water supply cylinder 230 over the whole length. With respect to the diameter of water spray pores 231, there is no particular limitation, but the diameter of the water spray pores can be, for example, in the range of from 0.1 to 5.0 mm.

Cleaning water feed device P1 for controlling the amount of the cleaning water fed into water supply cylinder 230 is connected to one end of water supply cylinder 230. From the viewpoint of facilitating the control of the cleaning water flow rate, cleaning water feed device P1 preferably comprises a flow rate controller, such as a constant delivery pump or a flow rate valve. The flow rate of the slurry and the concentration of the slurry in cleaning chamber 220 can be controlled by the flow rate of the cleaning water fed by cleaning water feed device P1.

The cleaning water fed into water supply cylinder 230 by cleaning water feed device P1 is sprayed through a plurality of water spray pores 231 formed in the outer periphery surface of water supply cylinder 230. Therefore, the cleaning water can be sprayed from the whole length and whole surface of water supply cylinder 230. Further, the cleaning water can be efficiently and uniformly fed into cleaning chamber 220.

A plurality of through-holes 233 through which a fluid can pass are formed in the outer periphery surface of inner cylinder member 232. With respect to the diameter of through-holes 233, there is no particular limitation, but the diameter of the through-holes can be, for example, in the range of from 1.0 to 10 mm.

Filtration member 236 in a cylindrical shape is fitted to the inner side of inner cylinder member 232. Filtration member 236 is supported by inner cylinder member 232 so that filtration member 236 is prevented from being deflected when receiving the pressure of the cleaning water. The both ends of filtration member 236 are fixed by being sandwiched between flange 216 and the end of inner cylinder member 232.

As filtration member 236, for example, a filter cloth can be used. As the filter cloth, any filter cloth can be used as long as it can separate the toner matrix particles or resin fine particles contained in the slurry. For example, a filter cloth made of a resin, such as nylon, polyester, or polypropylene, can be used. With respect to the size of the sieve opening of the filter cloth used, any size can be employed as long as it is a size such that the filter cloth can separate the toner matrix particles or resin fine particles contained in the slurry and does not excessively inhibit penetration of the cleaning water.

Slurry cleaning apparatus 210 has slurry feed device P2 and slurry discharge device P3. Slurry feed device P2 is a device for quantitatively feeding the slurry into cleaning chamber 220 through slurry inlet 212. Slurry discharge device P3 is a device for controlling the amount of the slurry discharged through slurry outlet 214.

Slurry feed device P2 and slurry discharge device P3 are a device that can control the flow rate of the slurry. Slurry feed device P2 and slurry discharge device P3 individually comprise, for example, a constant delivery pump, a flow rate controller, or a pressure regulating valve. By controlling the flow rate of the slurry, it is possible to adjust the concentration of the cleaned slurry.

The cleaning water sprayed through a plurality of water spray pores 231 formed in the outer periphery surface of water supply cylinder 230 is fed into cleaning chamber 220. The cleaning water fed into cleaning chamber 220 is contacted with the slurry in cleaning chamber 220. The cleaning water contacted with the slurry is subjected to filtration by filtration member 236 fitted to the inner side of inner cylinder member 232. Then, the cleaning water subjected to filtration by filtration member 236 passes through a plurality of through-holes 233 formed in inner cylinder member 232, and is stored in filtrate storage chamber 238 formed between inner cylinder member 232 and outer cylinder member 234. The cleaning water (filtrate) stored in filtrate storage chamber 238 is discharged to the outside through filtrate outlet 240 formed in the lower portion of filtrate storage chamber 238.

The filtration method may be either pressure filtration or filtration under a reduced pressure. In the case of pressure filtration, a pressure is applied to the feed-side cleaning water, so that the pressure of the feed-side cleaning water is higher than the pressure of the discharge-side cleaning water. In the case of filtration under a reduced pressure, the cleaning water is sucked from the discharge side to draw the feed-side cleaning water. By adjusting the pressure difference between the feed-side cleaning water and the discharge-side cleaning water, the filtration speed can be controlled. Further, by controlling the flow rate of the slurry and the flow rate of the cleaning water simultaneously, the cleaning efficiency can be precisely controlled. As a result, a stable cleaning effect can be obtained.

By slurry cleaning apparatus 210 of the present invention, the slurry and cleaning water can be efficiently contacted with each other in cleaning chamber 220. As a result, unnecessary components, such as a surfactant, an emulsifying agent, or a colorant added, for example, in the production process for a toner, or an excess resin which has not been incorporated into the toner matrix particles, can be efficiently removed.

In slurry cleaning apparatus 210 of the present invention, a plurality of water spray pores 231 are formed over the whole outer surface of water supply cylinder 230. By spraying the cleaning water from water spray pores 231, the cleaning water and the slurry can be efficiently contacted in a short time. As a result, the slurry can be uniformly cleaned in a short time.

By slurry cleaning apparatus 210 of the present invention, the slurry can be cleaned while flowing the slurry, and therefore the slurry can be cleaned more efficiently than a cleaning method in a batch-wise manner.

By slurry cleaning apparatus 210 of the present invention, filtration of the cleaning water can be made by filtration member 236 fitted to the inner side of inner cylinder member 232. Therefore, a large filtration area can be secured. As a result, the slurry can be cleaned in an extremely short time.

By slurry cleaning apparatus 210 of the present invention, it is possible to flow the slurry at a constant speed along the direction of the center axis of inner cylinder member 232. The slurry can be cleaned while flowing the slurry, and therefore it is possible to prevent solids, such as the toner, from being deposited on the surface of filtration member 236. As a result, the slurry can be stably cleaned over a long period of time.

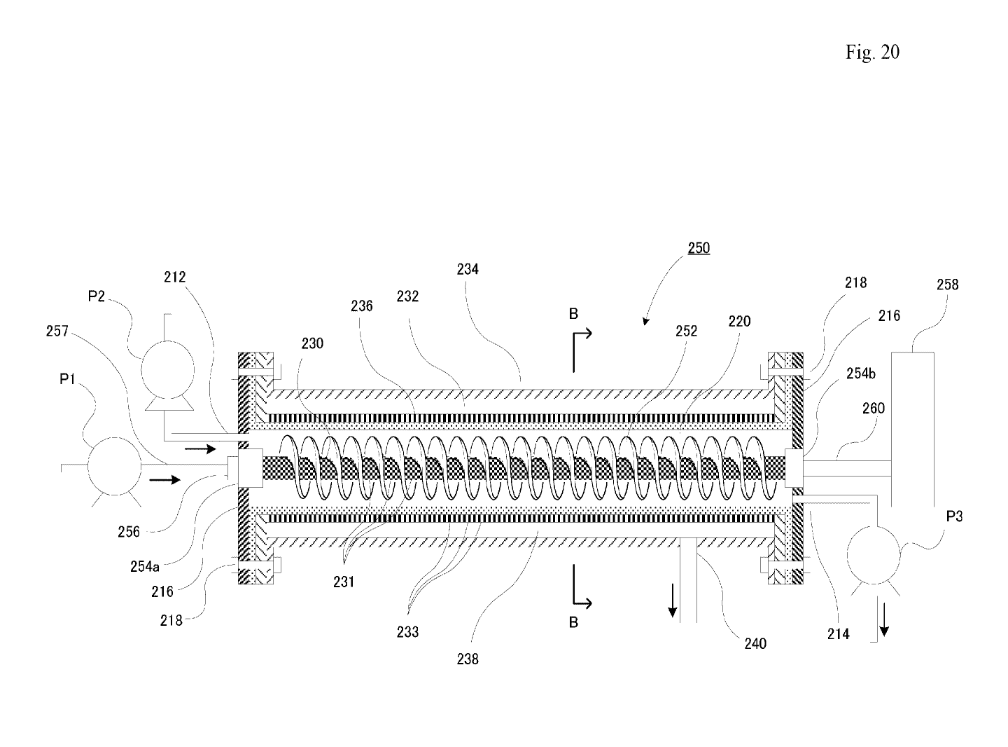

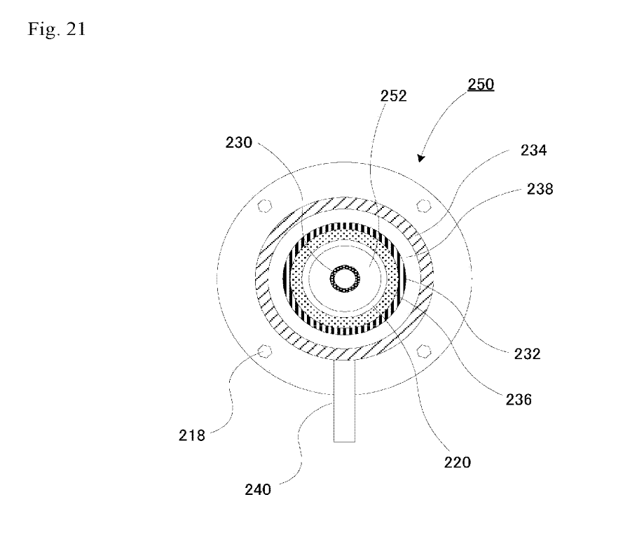

FIG. 20 is a cross-sectional view of a slurry cleaning apparatus according to another embodiment. FIG. 21 is a cross-sectional view of the slurry cleaning apparatus shown in FIG. 20, taken along line B-B.

As shown in FIG. 20, slurry cleaning apparatus 250 has water supply cylinder 230. Screw 252 in a spiral form is fitted to the outer periphery of water supply cylinder 230. Screw 252 can transfer the slurry from slurry inlet 212 toward slurry outlet 214.

Slurry cleaning apparatus 250 has rotation driving means 258 for rotating water supply cylinder 230 and screw 252. Rotation driving means 258 and water supply cylinder 230 are connected by connecting axis 260. The both ends of water supply cylinder 230 are rotatably supported by bearings 254a, 254b.

Slurry cleaning apparatus 250 has piping 257 extending from water pump P1. Piping 257 and water supply cylinder 230 are rotatably connected by rotary joint 256. The other construction of slurry cleaning apparatus 250 according to the present embodiment is the same as the corresponding construction of the above-mentioned slurry cleaning apparatus 210. In FIGS. 20 and 21 and the above-described slurry cleaning apparatus 210, like parts or portions are indicated by like reference numerals.

Slurry cleaning apparatus 250 functions as a cleaning apparatus which can clean the slurry. Simultaneously, slurry cleaning apparatus 250 functions as a screw conveyer which can transfer the slurry.

Slurry cleaning apparatus 250 can clean the slurry while transferring the slurry. When the slurry is cleaned by slurry cleaning apparatus 250, the path of movement of the slurry within cleaning chamber 220 is increased. Accordingly, the contact time of the slurry and the filtration side is increased, and therefore the filtration efficiency is improved. Further, scattering of the slurry can be prevented, and therefore the slurry can be cleaned more efficiently in a shorter time than a cleaning method in a batch-wise manner

In addition, the toner deposited on filtration member 236 is scraped between the outer periphery edge of screw 252 and filtration member 236. By virtue of such a scraping effect, the thickness of a deposit layer of solids, such as the toner, can be controlled. By controlling the thickness of the deposit layer of the toner, it is possible to prevent filtration member 236 from suffering clogging. As a result, the filtration speed can be stably maintained.

Screw 252 can prevent filtration member 236 from suffering clogging. Thus, the proportion of the amount of the cleaning water to the amount of the slurry can be increased. By increasing the proportion of the amount of the cleaning water, high cleaning effect can be realized.

With respect to screw 252, an example is shown in which the screw is a spiral blade that is continuously formed, but the screw may be of another mode. For example, screw 252 may comprise a plurality of blades fitted to the outer periphery surface of water supply cylinder 230. Screw 252 can be fitted to the outer periphery surface of water supply cylinder 230 by, for example, welding.

As rotation driving means 258 for rotating water supply cylinder 230 and screw 252, for example, an electric motor can be used. A power transmission element may be incorporated between rotation driving means 258 and connecting axis 260. As a power transmission element, for example, a gear, a belt, or a speed reducer can be used.

In slurry cleaning apparatus 250 according to the present embodiment, simultaneously with stirring the slurry by screw 252, the cleaning water is sprayed through a plurality of water spray pores 231 formed in the outer surface of water supply cylinder 230. Thus, the slurry and the cleaning water can be more efficiently mixed and contacted with each other than the above-mentioned slurry cleaning apparatus 210. Therefore, by slurry cleaning apparatus 250, the slurry can be efficiently cleaned in a shorter time.

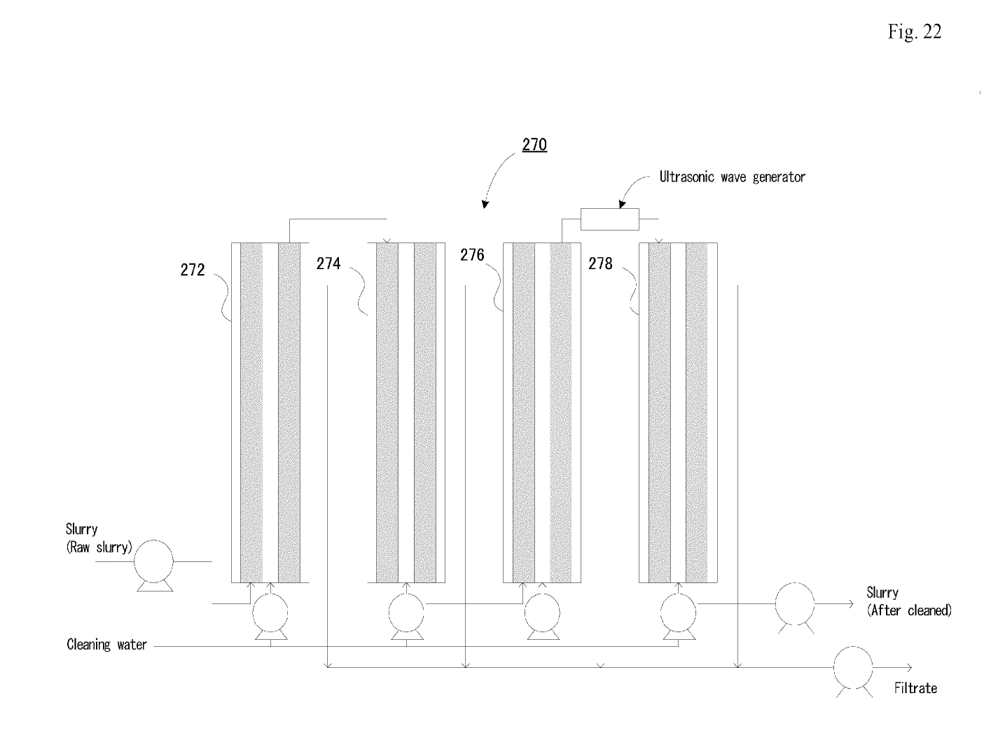

FIG. 22 shows an example of the construction of system 270 comprising a plurality (4) of slurry cleaning apparatuses connected in series.

As shown in FIG. 22, system 270 comprises first cleaning apparatus 272, second cleaning apparatus 274, third cleaning apparatus 276, and fourth cleaning apparatus 278. First to fourth cleaning apparatuses 272, 274, 276, 278 individually have the same construction as that of the above-described slurry cleaning apparatus 210 or slurry cleaning apparatus 250.

The slurry outlet of first cleaning apparatus 272 is connected to the slurry inlet of second cleaning apparatus 274. The slurry outlet of second cleaning apparatus 274 is connected to the slurry inlet of third cleaning apparatus 276. The slurry outlet of third cleaning apparatus 276 is connected to the slurry inlet of fourth cleaning apparatus 278. Therefore, the slurry fed through the slurry inlet of first cleaning apparatus 272 is cleaned by first cleaning apparatus 272, second cleaning apparatus 274, third cleaning apparatus 276, and fourth cleaning apparatus 278, and then discharged through the slurry outlet of fourth cleaning apparatus 278.

By using a plurality of the slurry cleaning apparatuses which are connected in series, unnecessary components contained in the slurry, such as a surfactant, can be efficiently removed in a shorter time.

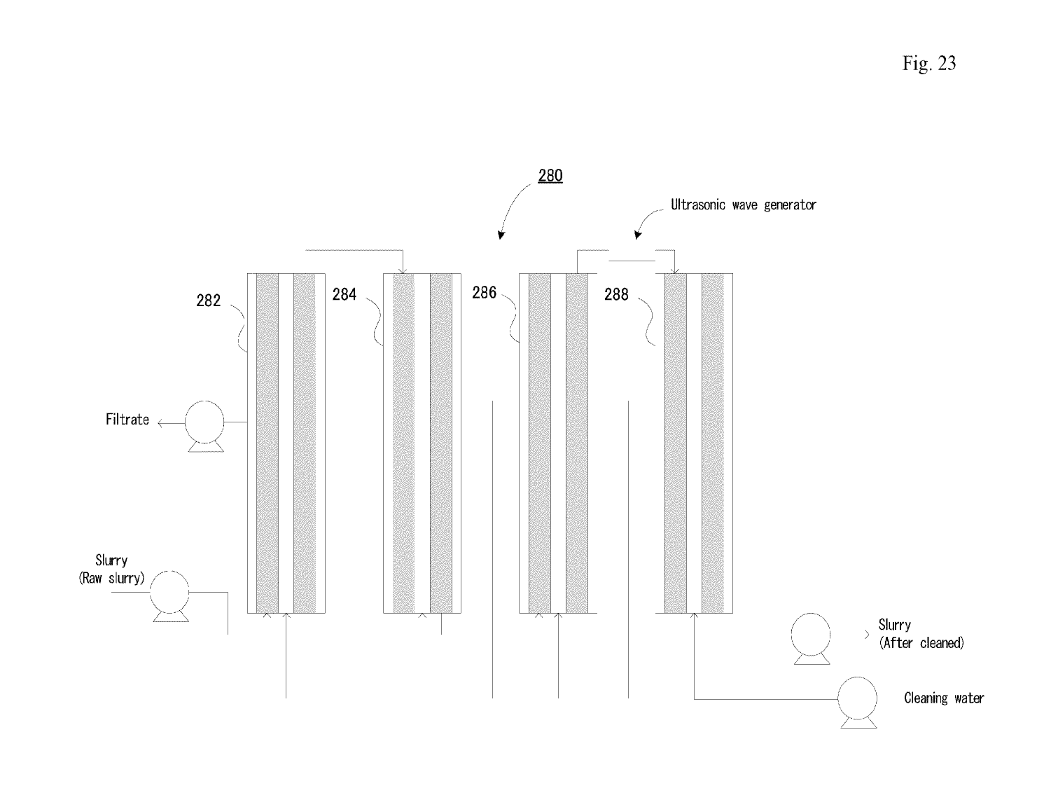

FIG. 23 shows an example of the construction of system 280 comprising a plurality (4) of slurry cleaning apparatuses 210 which are connected in series.

As shown in FIG. 23, like system 270, system 280 comprises first cleaning apparatus 282, second cleaning apparatus 284, third cleaning apparatus 286, and fourth cleaning apparatus 288. First to fourth cleaning apparatuses 282, 284, 286, 288 individually have the same construction as that of the above-described slurry cleaning apparatus 210. The piping for first to fourth cleaning apparatuses 282, 284, 286, 288 constituting system 280 is connected in substantially the same manner as in system 270 except the piping for the cleaning water.

With respect to the connection of the piping for flowing the cleaning water and filtrate, in the case of system 280, the direction of flow of the cleaning water and the direction of flow of the slurry are opposite. The cleaning water outlet of fourth cleaning apparatus 288 is connected to the cleaning water inlet of third cleaning apparatus 286. The cleaning water outlet of third cleaning apparatus 286 is connected to the cleaning water inlet of second cleaning apparatus 284. The cleaning water outlet of second cleaning apparatus 284 is connected to the cleaning water inlet of first cleaning apparatus 282. Therefore, the cleaning water fed through the cleaning water inlet of fourth cleaning apparatus 288 is mixed with the slurry and subjected to filtration in fourth cleaning apparatus 288, third cleaning apparatus 286, second cleaning apparatus 284, and first cleaning apparatus 282, and then discharged as a filtrate through the cleaning water outlet of first cleaning apparatus 282. When the direction of flow of the slurry and the direction of flow of the cleaning water are opposite as mentioned above, the slurry can be cleaned with the cleaning water in a further reduced amount.

Further, for more quickly removing impurities, such as an emulsifying agent adhering to the surface of the core particles, if necessary, an ultrasonic wave generator or a temperature controller can be employed. The ultrasonic wave generator or temperature controller can be located in slurry cleaning apparatus 10. The ultrasonic wave generator or temperature controller can also be located in the circuit between the slurry cleaning apparatuses through which the slurry flows.

The ultrasonic wave generator can be located in a cleaning system comprising a plurality of the slurry cleaning apparatuses. It is preferred that the ultrasonic wave generator is located in a position which is present in the latter half of the cleaning system and before the slurry cleaning apparatus at the end. When the ultrasonic wave generator is located in the first half of the cleaning system, a large amount of impurities remaining in the slurry, together with the toner, make it difficult to obtain the cleaning effect of ultrasonic waves for the surface of the toner. When the ultrasonic wave generator is located after the slurry cleaning apparatus at the end, impurities, such as an emulsifying agent removed by ultrasonic waves from the surface of the toner, are mixed into the slurry, leading to a danger that the subsequent steps are adversely affected. By introducing the ultrasonic wave generator, not only an improvement of the cleaning efficiency for the toner but also an effect of redispersing flocculate of the toner particles caused during the cleaning can be expected.

The temperature controller can be located in the slurry cleaning apparatus, the circuit between the apparatuses through which the slurry flows, or the circuit through which the cleaning water flows. The temperature of the slurry controlled by the temperature controller is preferably set to be a temperature lower than the glass transition point and melting point of the resin component constituting the toner particles. When the temperature of the slurry is set to be higher than the glass transition point and melting point of the resin component, there is a danger that flocculate of the toner particles is caused during the cleaning.

The temperature control upon cleaning the slurry can also be achieved by controlling the temperature of the cleaning water used. Even in such a case, for the same reason as mentioned above, the temperature of the cleaning water is preferably set to be a temperature lower than the glass transition point and melting point of the resin component constituting the toner particles.

The ultrasonic wave generator and the temperature controller can be simultaneously used, and can also be individually or separately used. By subjecting the slurry containing the toner particles to ultrasonic treatment or controlling the temperature of the slurry, it is possible to more efficiently remove impurities adhering to the surface of the toner particles. As a result, not only can the cleaning efficiency for the toner particles be improved, but also the toner particles can be cleaned in a short time.

The slurry cleaning apparatus of the present invention can be especially preferably used in producing the toner matrix particles having a core/shell structure. Particularly, the slurry cleaning apparatus of the present invention can be preferably applied to the cleaning step for the slurry containing core particles or shell particles, which is required to strictly control the charge state of the surface of the particles.

### EXAMPLES

Hereinbelow, the present invention will be described in more detail with reference to the following Examples, which should not be construed as limiting the scope of the present invention. In the following Examples, “part(s)” means “part(s) by mass”. The actual tests were conducted by the methods described below.

A particle diameter, a roundness, an electrical conductivity, and thermal properties were measured as described below.

<Median Diameter (D50)>

A median diameter (D50) of the particles of less than 1 micron was measured using Model MicrotracNanotrac 150, manufactured by Nikkiso Co., Ltd. (hereinafter, referred to simply as “Nanotrac”), and using an analysis software MicrotracParticle Analyzer Vcr 10.1.2-019EE, manufactured by Nikkiso Co., Ltd. Conditions for the measurement are as follows.

Solvent: Ion-exchanged water having an electrical conductivity of 0.5 μS/cm
Refractive index of the solvent: 1.333
Measuring time: 600 seconds
Frequency of measurement: 1
Refractive index of the particles: 1.59
Transmission property: Transmission
Shape of the particles: True sphere
Density of the particles: 1.04

<Volume Median Diameter (Dv50)>

A volume median diameter (Dv50) of the particles of 1 micron or more was measured using Multisizer III, manufactured by Beckman Coulter, Inc. (aperture diameter: 100 μm; hereinafter, referred to simply as “Multisizer”). The particles were dispersed in ISOTON II, manufactured by Beckman Coulter, Inc., as a dispersing medium so that the dispersoid concentration became 0.03%, and a volume median diameter was measured.

<Average Roundness>

An average roundness was measured using a flow-type particle analyzer (FPIA 3000, manufactured by Sysmex Corporation). For the measurement, a dispersoid was dispersed in a dispersing medium. Conditions for the measurement are as follows.

Dispersing medium: Serushisu (manufactured by Sysmex Corporation)
Dispersoid concentration: 5,720 to 7,140 counts/μl
Amount per HPF analysis: 0.35 μl
Amount per HPF detection: 2,000 to 2,500 counts
Measurement mode: HPF mode

<Electrical Conductivity>

An electrical conductivity was measured using a conductivity meter (CyberScanCON 100, manufactured by AS ONE Corporation).

<Weight Average Molecular Weight (Mw)>

With respect to the THF-soluble component of the polymer primary particle dispersion, a measurement by gel permeation chromatography (GPC) was performed under the following conditions.

Measurement apparatus: GPC apparatus HLC-8020, manufactured by Tosoh Corp.
Column: PL-gel Mixed-B 10μ, manufactured by Polymer Laboratories Ltd.

### Solvent: THF

Sample concentration: 0.1% by weight
Calibration curve: Standard polystyrene

### Example 1

### Preparation of Wax Dispersion A1

### <Preparation of Wax/Long-Chain Polymerizable Monomer Dispersion A1>

100 Parts of a paraffin wax (HNP-9, manufactured by Nippon Seiro Co., Ltd.; melting point: 82° C.), 10.4 parts of stearyl acrylate, 7.0 parts of a 20% aqueous solution of sodium dodecylbenzenesulfonate (NEOGEN S20D, manufactured by Dai-ichi Kogyo Seiyaku Co., Ltd.; hereinafter, referred to simply as “20% aqueous DBS solution”), and 253.0 parts of desalted water were mixed with one another. The resultant mixture was heated to 90° C., and stirred using a homomixer (MARK IIf Model, manufactured by Tokushu Kika Kogyo Co., Ltd.) for 10 minutes. Then, while heating at 90° C., circulation emulsification was started under pressure conditions at 20 MPa using a high-pressure emulsifier. A particle diameter was measured by Nanotrac. The wax was dispersed until the median diameter (D50) became 500 nm or less to prepare emulsion A1. The median diameter (D50) was found to be 250 nm.

<Preparation of Polymer Primary Particle Dispersion B1>

A reactor equipped with a stirring apparatus (having three blades), a heating and cooling apparatus, a condenser, and an apparatus for charging the raw materials and auxiliaries was provided. 35.8 Parts of wax dispersion A1 and 260 parts of desalted water were charged into the reactor, and the resultant mixture was heated to 90° C. in a nitrogen gas flow while stirring.

Then, while stirring, a mixture of the below-shown monomers and emulsifying agent solution was added to the reactor over 300 minutes. The addition of the mixture of the monomers and aqueous emulsifying agent solution to the reactor initiates polymerization. After 30 minutes from the initiation of polymerization, the below-shown aqueous initiator solution 1 was added over 270 minutes. Aqueous initiator solution 2 was further added over 60 minutes. Then, while stirring, the temperature in the reactor was maintained at 90° C. for one hour.

[Monomers]

| | | |
|---|---|---|
| Styrene | 72.3 | Parts |
| Butyl acrylate | 27.7 | Parts |
| Acrylic acid | 1.5 | Parts |
| Trichlorobromomethane | 1.0 | Part |
| Hexanediol diacrylate | 0.9 | Part |

[Aqueous Emulsifying Agent Solution]

| | | |
|---|---|---|
| 20% Aqueous DBS solution | 1.0 | Part |
| Desalted water | 67.3 | Parts |

[Aqueous Initiator Solution 1]

8% Aqueous solution of hydrogen peroxide 15.5 Parts
8% Aqueous solution of L-(+)ascorbic acid 15.5 Parts

[Aqueous Initiator Solution 2]

8% Aqueous solution of L-(+)ascorbic acid 14.2 Parts

After completion of the polymerization reaction, the reactor was cooled. From the inside of the reactor, milky-white polymer primary particle dispersion B1 was obtained. With respect to the particles contained in polymer primary particle dispersion B1, a median diameter (D50) was measured using Nanotrac. The median diameter (D50) was found to be 270 nm. The weight average molecular weight (Mw) was found to be 68,000.

<Production of Toner Matrix Particles C1>

A mixer equipped with a stirring apparatus (having a double-helical blade), a heating and cooling apparatus, a condenser, and an apparatus for charging the raw materials and auxiliaries was provided. 100 Parts (in terms of a solids content) of polymer primary particle dispersion B1 was charged into the mixer at room temperature (about 25° C.). 4.4 Parts (in terms of a solids content) of a cyan pigment dispersion (EP700, manufactured by Dainichiseika Color & Chemicals Mfg. Co., Ltd.) was added to dispersion B1 over 5 minutes. These were uniformly mixed in the mixer, and then 0.3 part (in terms of a solids content) of a 0.5% aluminum sulfate solution was dropwise added to the mixer. Then, the temperature in the reactor was increased to 52° C. by heating over 100 minutes. Using Multisizer, a volume median diameter (Dv50) was measured with respect to the particles contained in the mixture. After the median diameter of the particles exceeded 6.8 microns, 4.0 parts (in terms of a solids content) of a 20% aqueous DBS solution was added to the mixture. The resultant mixture was heated to 97° C. over 50 minutes, and then that temperature was maintained for 90 minutes.

Then, the inside of the mixer was cooled to 30° C. over 20 minutes. Thus, from the inside of the mixer, a slurry which is a dispersion of toner matrix particles C1 was obtained.

With respect to the particles contained in the slurry, a volume median diameter (Dv50) was measured using Multisizer III. The median diameter was found to be 7.0 μm.

With respect to the particles contained in the slurry, an average roundness was measured using a flow-type particle analyzer. The average roundness was found to be 0.98.

<Preparation of Slurry D1 Containing the Toner Matrix Particles>

With respect to the slurry which is a dispersion of toner matrix particles C1, a solids content was measured. Desalted water was added to the slurry so that the solids content of the resultant slurry became 15%. The slurry having a solids content adjusted to 15% is used as slurry D1. Slurry D1 had an electrical conductivity of 3,500 μs.

Using the above-described slurry cleaning apparatus, the slurry having a solids content of 15% was cleaned. The slurry was cleaned until the electrical conductivity of slurry D1 became the target value or less.

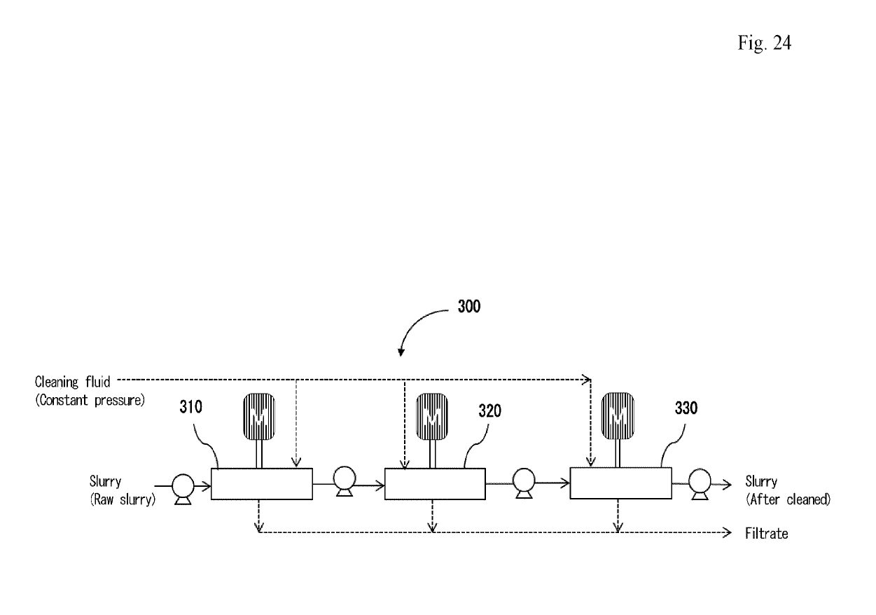

Using slurry cleaning system 300 shown in FIG. 24, slurry D1 was cleaned.

System 300 comprises first cleaning apparatus 310, second cleaning apparatus 320, and third cleaning apparatus 330. First to third cleaning apparatuses 310, 320, 330 individually have the same construction as that of slurry cleaning apparatus 110 shown in FIG. 12. The inner diameter of each of first to third cleaning apparatuses 310, 320, 330 is 105 mm.

Slurry D1 was fed to the slurry inlet of first cleaning apparatus 310. The slurry was fed by four constant delivery pumps P11, P12, P13, P14. Pump P11 is located before first cleaning apparatus 310. Pump P12 is located between first cleaning apparatus 310 and second cleaning apparatus 320. Pump P13 is located between second cleaning apparatus 320 and third cleaning apparatus 330. Pump P14 is located after third cleaning apparatus 330. The four constant delivery pumps P11, P12, P13, P14 were set to have the same feed rate.

Slurry D1 fed to the slurry inlet of first cleaning apparatus 310 passed through first cleaning apparatus 310, second cleaning apparatus 320, and third cleaning apparatus 330, and then was discharged from the slurry outlet of third cleaning apparatus 330. The solids content of slurry D1 after cleaned by first to third cleaning apparatuses 310, 320, 330 was the same as that of slurry D1 before fed to first cleaning apparatus 310.

Cleaning water was fed into the cleaning chambers through the cleaning water inlets formed in the respective upper portions of first to third cleaning apparatuses 310, 320, 330. Slurry D1 and the cleaning water were mixed with each other in each cleaning chamber. The cleaning water mixed with slurry D1 was subjected to filtration by the filtration member located below each cleaning chamber. The resultant filtrate containing soluble components, such as an electrolyte, was discharged from the cleaning water outlet formed in the lower portion of each cleaning chamber. Thus, slurry D1 having a soluble component concentration controlled was obtained. As the filtration member, PP312B filter cloth, manufactured by Nakao Filter Co., Ltd. (gas permeability: 1.3 cm³/cm²·sec), was used.

Agitating blades were located in the cleaning chambers in a cylindrical shape of first to third cleaning apparatuses 310, 320, 330. The number of revolutions of the agitating blade was set at 150 rpm. The feed rate of slurry D1 was set at 50 g/min.

The cleaning water was fed into the cleaning chambers through the cleaning water inlets formed in the respective upper portions of the cleaning apparatuses. As cleaning water, desalted water having an electrical conductivity of 1 μs or less was used. The feed pressure for the cleaning water was set at 0.2 MPa. The filtrate extruded from each cleaning chamber through the cleaning water outlet formed in the lower portion of the cleaning chamber was continuously recovered. The solids content of slurry D1 which had passed through first to third cleaning apparatuses 310, 320, 330 was the same as that of slurry D1 before fed to first cleaning apparatus 310, and was 15%.

Slurry D1 which had passed through first to third cleaning apparatuses 310, 320, 330 had an electrical conductivity of 26 μs.

With respect to the toner matrix particles contained in slurry D1 which had passed through first to third cleaning apparatuses 310, 320, 330, a roundness was measured by FPIA. As a result, the roundness was found to be 0.97.

A ratio of the electrical conductivity values of the slurry before cleaned and the slurry after cleaned was determined by making a calculation.

A feed rate of the slurry was measured.

A feed rate of the cleaning water was measured.

A cleaning ratio (=rate of the cleaning water/rate of the slurry) was determined by making a calculation.

A cleaning efficiency (=electrical conductivity ratio/cleaning ratio) was determined by making a calculation.

With respect to the toner matrix particles contained in the slurry before cleaned and the slurry after cleaned, roundness values were individually measured. A comparison was made between the roundness values of the toner matrix particles before and after the cleaning.

The results are shown in Table 2 below.

### Example 2

Desalted water was added to slurry D1 having a solids content of 15% to prepare slurry D2 having a solids content of 10%. Slurry D2 had an electrical conductivity of 2,000 μs. Slurry D2 was cleaned using the same slurry cleaning system 300 as in Example 1 under the same conditions as those in Example 1. The slurry D2 after cleaned had an electrical conductivity of 13 μs. With respect to the toner matrix particles contained in the cleaned slurry D2, a roundness was measured by FPIA. As a result, the roundness was found to be 0.97.

### Example 3

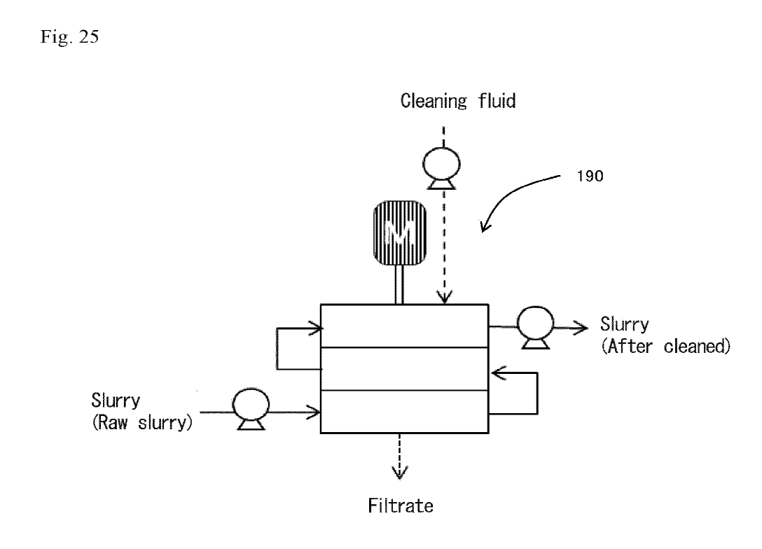

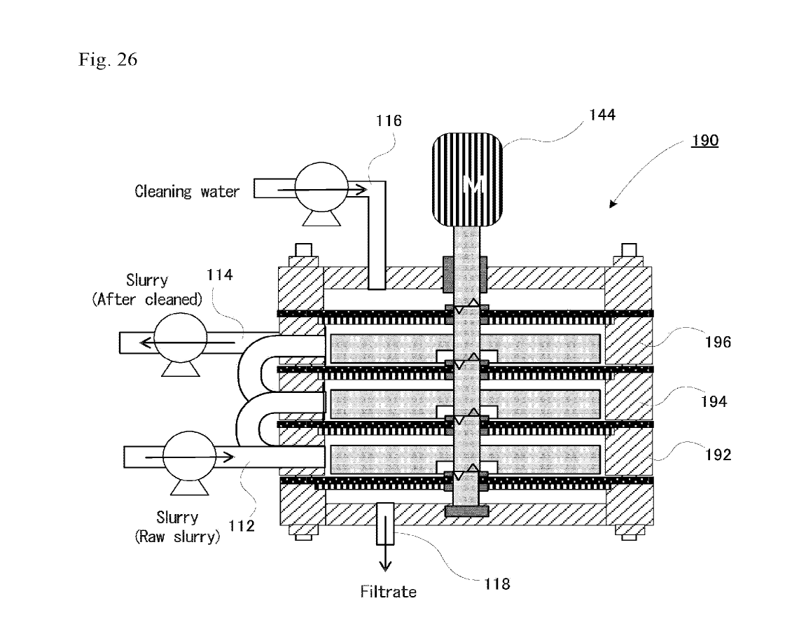

Using stacking-type slurry cleaning apparatus 190 shown in FIGS. 25 and 26, slurry D1 was cleaned. The inner diameter of cleaning apparatus 190 is 105 mm. Cleaning apparatus 190 comprises first cleaning apparatus 192, second cleaning apparatus 194, and third cleaning apparatus 196. Cleaning apparatus 190 has substantially the same construction as that of cleaning apparatus 160 shown in FIGS. 14 and 15 except that the number of the stacked apparatuses is changed to 3 from 4.

Slurry D1 was fed to the slurry inlet of first cleaning apparatus 192. The slurry was fed by two constant delivery pumps respectively located at the slurry inlet of first cleaning apparatus 192 and at the slurry outlet of third cleaning apparatus 196. The two constant delivery pumps were set to have the same feed rate.

Slurry D1 fed to the slurry inlet of first cleaning apparatus 192 passed through first cleaning apparatus 192, second cleaning apparatus 194, and third cleaning apparatus 196, and then was discharged from the slurry outlet of third cleaning apparatus 196. The solids content of slurry D1 after cleaned by first to third cleaning apparatuses 192, 194, 196 was the same as that of slurry D1 before fed to first cleaning apparatus 192.

Cleaning water was fed into the cleaning chamber through the cleaning water inlet formed in the upper portion of cleaning apparatus 190. Slurry D1 and the cleaning water were mixed with each other in the cleaning chamber. The cleaning water mixed with slurry D1 was subjected to filtration by the filtration members respectively located in first to third cleaning apparatuses 192, 194, 196. The resultant filtrate containing soluble components, such as an electrolyte, was discharged from the cleaning water outlet formed in the lower portion of first cleaning apparatus 192. Thus, slurry D1 having a soluble component concentration controlled was obtained. The other cleaning conditions were the same as those in Example 1.

Slurry D1 which had passed through first to third cleaning apparatuses 192, 194, 196 had an electrical conductivity of 13 μs.

With respect to the toner matrix particles contained in slurry D1 which had passed through first to third cleaning apparatuses 192, 194, 196, a roundness was measured by FPIA. As a result, the roundness was found to be 0.97.

### Example 4

A cleaning test for slurry D1 was conducted in substantially the same manner as in Example 3 except that the method of feeding the cleaning water was changed to a method of quantitatively feeding the cleaning water by means of a constant delivery pump from the method of feeding the cleaning water at a constant pressure.

Slurry D1 which had passed through first to third cleaning apparatuses 192, 194, 196 had an electrical conductivity of 57 μs.

With respect to the toner matrix particles contained in slurry D1 which had passed through first to third cleaning apparatuses 192, 194, 196, a roundness was measured by FPIA. As a result, the roundness was found to be 0.97.

### Example 5

Using slurry cleaning apparatus 250 shown in FIGS. 20 and 21, slurry D1 was cleaned. The inner diameter of cleaning apparatus 250 is 32 mm.

Slurry D1 was fed to the slurry inlet of cleaning apparatus 250. The slurry was fed by two constant delivery pumps respectively located at the slurry inlet and slurry outlet of cleaning apparatus 250. The two constant delivery pumps were set to have the same feed rate. The feed rate of the slurry was set at 50 g/min.

Slurry D1 fed to slurry inlet 212 of cleaning apparatus 250 was transferred by screw 252 inside cleaning chamber 220, and then discharged from slurry outlet 214. The solids content of slurry D1 after cleaned by cleaning apparatus 250 was the same as that of slurry D1 before fed to cleaning apparatus 250.

Cleaning water was fed into water supply cylinder 230 through piping 257. The cleaning water was sprayed through a plurality of water spray pores 231 formed in the outer periphery of water supply cylinder 230. In cleaning chamber 220, slurry D1 and the cleaning water were mixed with each other simultaneously with transferring the slurry by screw 252. The cleaning water mixed with slurry D1 was subjected to filtration by filtration member 236 fitted to the inner side of inner cylinder member 232. The resultant filtrate containing soluble components, such as an electrolyte, was discharged from filtrate outlet 240 formed in the lower portion of cleaning chamber 220. Thus, slurry D1 having a soluble component concentration controlled was obtained. The other cleaning conditions were the same as those in Example 1.

Slurry D1 which had passed through cleaning apparatus 250 had an electrical conductivity of 30 μs.

With respect to the toner matrix particles contained in slurry D1 which had passed through cleaning apparatus 250, a roundness was measured by FPIA. As a result, the roundness was found to be 0.97.

### Example 6

A cleaning test for slurry D1 was conducted in substantially the same manner as in Example 5 except that the feed rate of the slurry was changed to 26 g/minute from 50 g/minute.

Slurry D1 which had passed through cleaning apparatus 250 had an electrical conductivity of 17 μs.

With respect to the toner matrix particles contained in slurry D1 which had passed through cleaning apparatus 250, a roundness was measured by FPIA. As a result, the roundness was found to be 0.97.

### Example 7

Using slurry cleaning apparatus 110 shown in FIG. 12, the slurry was cleaned under the same cleaning conditions as those in Example 1, and the filtration performance of the filtration member was evaluated.

Specifically, a filtration ratio upon cleaning (=rate of the cleaning water/rate of the slurry) was determined by making a calculation.

The filtration performance of the filtration member was evaluated in accordance with the following criteria.

Filtration ratio >=10: ⊚

10>Filtration ratio >=1: ∘

1>Filtration ratio: x

Then, a time (t) required until the color of the filtrate discharged from the cleaning chamber was visually recognized as transparent one after starting feeding the slurry to the cleaning chamber was measured.

The particle retaining property of the filtration member was evaluated in accordance with the following criteria.

t<5 minutes: ⊚

5 minutes=<t=<10 minutes: ∘

t>10 minutes: x

The results of evaluation of the filtration performance and particle retaining property of the filtration member are shown in Table 1 below.

TABLE 1

| Filter cloth No. | 1 | 2 | 3 | 4 | 5 | 6 | 7 | 8 |
|---|---|---|---|---|---|---|---|---|
| Weave pattern | Plain | Twill | Twill | Twill | Satin | Double | Double | Satin |
| | weave | weave | weave | weave | weave | plain weave | weave | weave |
| Warp | Multi | Spun | Spun | Multi | Mono | Mono | Multi | Mono |
| Weft | Multi | Spun | Spun | Multi | Mono | Mono | Multi | Multi |
| Gas permeability | 1.3 | 0.95 | 1.7 | 4 | 2.6 | 2.1 | 0.4 | 0.21 |
| (cm³/cm²sec) | | | | | | | | |
| Filtration performance | ◯ | ◯ | ◯ | ◯ | ◯ | ◯ | X | X |
| Particle retaining property | ⊚ | ⊚ | ◯ | X | X | X | ◯ | X |

### Comparative Example 1

Slurry D1 prior to cleaning obtained in Example 1 was subjected to filtration by means of suction (first filtration) using an aspirator. In the filtration by means of suction, filter paper (NO. 5C, manufactured by Toyo Roshi Kaisha, Ltd.) was used.

The cake remaining on the filter paper was transferred to a stainless steel vessel equipped with a stirrer (having a propeller blade). Ion-exchanged water having an electrical conductivity of 1 μS/cm was added to the cake in the stainless steel vessel. The cake was stirred by means of the stirrer so that the cake was uniformly dispersed in the ion-exchanged water. The number of revolutions of the stirrer was set at 50 rpm. Then, stirring was continued for 30 minutes.

After stirring, the resultant slurry was further subjected to filtration by means of suction (second filtration) using an aspirator. In the second filtration by means of suction, the same filter paper as the filter paper used in the first filtration by means of suction was used.

The cake remaining on the filter paper was transferred to a stainless steel vessel equipped with a stirrer (having a propeller blade). Ion-exchanged water having an electrical conductivity of 1 μS/cm was added to the cake in the stainless steel vessel. The cake was stirred by means of the stirrer so that the cake was uniformly dispersed in the ion-exchanged water. The number of revolutions of the stirrer was set at 50 rpm. Then, stirring was continued for 30 minutes.

The slurry obtained after the second stirring had an electrical conductivity of 25 μs.

With respect to the toner matrix particles contained in the slurry obtained after the second stirring, a roundness was measured by FPIA. As a result, the roundness was found to be 0.96.

The results of Examples 1 to 6 and Comparative Example 1 are shown in Table 2 below.

[Table 2]

TABLE 2

| | Example | | | | | | |
|---|---|---|---|---|---|---|---|
| | | | | | | | Comparative |
| | Example 1 | Example 2 | Example 3 | Example 4 | Example 5 | Example 6 | Example 1 |
| Cleaning method | Continuous | Continuous | Continuous | Continuous | Continuous | Continuous | Batch |
| | cleaning | cleaning | cleaning | cleaning | cleaning | cleaning | |
| Cleaning apparatus | FIG. 24 | FIG. 24 | FIGS. | FIGS. | FIGS. | FIGS. | Filtration/ |
| | | | 25-26 | 25-26 | 20-21 | 20-21 | dispersion |
| Type | Single-layer, | Single-layer, | Three-layer, | Three-layer, | Single body, | Single body, | Filtration by |
| | Three | Three | Single | Single | Single | Single | means of |
| | apparatuses | apparatuses | apparatus | apparatus | apparatus | apparatus | suction |
| Reslurry | — | — | — | — | — | — | Twice |
| Cleaning water | Constant | Constant | Constant | Constant | Constant | Constant | Constant |
| feeding method | pressure | pressure | pressure | delivery | pressure | pressure | delivery |
| Cleaning ratio | 21 | 26 | 10 | 5.6 | 10 | 20 | 16 |
| Electrical conductivity | 136 | 154 | 231 | 68 | 117 | 206 | 140 |
| ratio (before cleaning/ | | | | | | | |
| after cleaning) | | | | | | | |
| Cleaning efficiency | 6 | 6 | 23 | 12 | 12 | 10 | 9 |
| Change of roundness | No | No | No | No | No | No | Changed |
| between before and | change | change | change | change | change | change | |
| after cleaning | | | | | | | |

As seen from Table 2, in Examples 1 to 6, the soluble substance contained in the slurry was able to be continuously and efficiently removed. Further, when removing the soluble substance contained in the slurry, the slurry did not become to be in a cake form, and therefore it was possible to suppress the generation of flocculate of the particles contained in the slurry.

For efficiently cleaning the slurry using the slurry cleaning apparatus, it is desired that a filtration member having excellent filtration performance and excellent particle retaining property is used.

As seen from the results shown in Table 1, the gas permeability of the filtration member is preferably higher than 0.2 to smaller than 4. The gas permeability of the filtration member is more preferably 0.5 to 2.

For improving the particle retaining property, when the filtration member is a filter cloth, it is preferred that the weave pattern of the filter cloth is plain weave or twill weave. Further, the type of yarn is preferably a multi yarn or a spun yarn.

### DESCRIPTION OF REFERENCE NUMERALS

10, 110, 210, 250: Slurry cleaning apparatus
12, 112, 212: Slurry inlet
14, 114, 214: Slurry outlet
16, 116: Cleaning water inlet
18, 118: Cleaning water outlet
20, 120, 220: Cleaning chamber
22, 122: First filtration side
24, 124: Second filtration side
26, 126: Cleaning water storage chamber
28, 128, 238: Filtrate storage chamber
30, 130: Upper member
32, 132: Intermediate member
34, 134: Lower member
46: Slurry feed device
48: Slurry discharge device
50: Cleaning water quantitative feed device
60: Slurry cleaning apparatus (having a circular cross-section)
70: Slurry cleaning apparatus (having a circular cross-section and having an agitating blade)
72: Agitating blade
140: Delivery means
142: Blade member
150: Ultrasonic wave generator
160: Stacking-type slurry cleaning apparatus
170, 180, 270, 280: Slurry cleaning system
190: Stacking-type slurry cleaning apparatus
230: Water supply cylinder
231: Water spray cylinder
232: Inner cylinder member
233: Through-hole
234: Outer cylinder member
236: Filtration member
238: Filtrate storage chamber
240: Filtrate outlet
252: Screw
258: Rotation driving means

1. A slurry cleaning apparatus, comprising:
a cleaning chamber for contacting a slurry with cleaning water; and
flow rate controllers for controlling the flow rate of the slurry,
wherein:
the flow rate controllers are located respectively at a slurry inlet through which the slurry is fed to the cleaning chamber and at a slurry outlet through which the slurry is discharged from the cleaning chamber;
the cleaning chamber comprises at least one filtration side having water permeability, the cleaning chamber being constructed so that the slurry flows at a constant flow rate in a space in contact with the filtration side; and
the cleaning water is fed to the cleaning chamber and brought into contact with the slurry flowing in the space, and then passes through the filtration side.

2. The slurry cleaning apparatus according to claim 1, wherein:
the cleaning chamber has the two or more filtration sides having water permeability; and
the cleaning water is fed to the cleaning chamber through one of the two or more filtration sides.

3. The slurry cleaning apparatus according to claim 2, wherein the filtration side through which the cleaning water passes when feeding the cleaning water to the cleaning chamber, and the filtration side through which the cleaning water passes when filtering the slurry, are switched in the course of the cleaning.

4. The slurry cleaning apparatus according to claim 1, further comprising a cleaning water feed device for feeding the cleaning water to the cleaning chamber, wherein the cleaning water is fed by the cleaning water feed device to the cleaning chamber at a constant flow rate.

5. The slurry cleaning apparatus according to claim 4, wherein the flow rate of the slurry and the slurry concentration in the cleaning chamber are controlled by the flow rate of the cleaning water fed by the cleaning water feed device.

6. The slurry cleaning apparatus according to claim 1, wherein the slurry and cleaning water are mechanically mixed with each other in the cleaning chamber.

7. The slurry cleaning apparatus according to claim 1, further comprising an ultrasonic wave generator.

8. The slurry cleaning apparatus according to claim 1, further comprising a temperature controller.

9. The slurry cleaning apparatus according to claim 1, wherein the slurry is a slurry containing resin fine particles.

10. The slurry cleaning apparatus according to claim 1, wherein the slurry is a slurry containing toner matrix particles obtained by an emulsion polymerization aggregation method.

11. A slurry cleaning system, comprising a plurality of slurry cleaning apparatuses according to claim 1.

12. A slurry cleaning apparatus, comprising:
a cleaning chamber for contacting a slurry with cleaning water; and
flow rate controllers for controlling the flow rate of the slurry,
wherein:
the flow rate controllers are located respectively at a slurry inlet through which the slurry is fed to the cleaning chamber and at a slurry outlet through which the slurry is discharged from the cleaning chamber;
the cleaning chamber comprises at least one filtration side having water permeability, the cleaning chamber being constructed so that the slurry flows in a space in contact with the filtration side;
the cleaning water is fed to the cleaning chamber and brought into contact with the slurry flowing in the space, and then passes through the filtration side; and
the cleaning chamber has a delivery device disposed therein for sending the slurry from the slurry inlet toward the slurry outlet.

13. The slurry cleaning apparatus according to claim 12, wherein the delivery device comprises a rotatable blade member disposed in the cleaning chamber.

14. The slurry cleaning apparatus according to claim 12, wherein:
the cleaning chamber is formed in a substantially cylindrical shape; and
the slurry inlet and the slurry outlet are formed in the outer periphery of the cleaning chamber at different positions in the circumferential direction.

15. The slurry cleaning apparatus according to claim 12, wherein:
the cleaning chamber has the two or more filtration sides having water permeability; and
the cleaning water is fed to the cleaning chamber through one of the two or more filtration sides.

16. The slurry cleaning apparatus according to claim 12, further comprising a cleaning water feed device for feeding the cleaning water to the cleaning chamber, wherein the cleaning water is fed by the cleaning water feed device to the cleaning chamber at a constant flow rate.

17. The slurry cleaning apparatus according to claim 16, wherein the flow rate of the slurry and the slurry concentration in the cleaning chamber are controlled by the flow rate of the cleaning water fed by the cleaning water feed device.

18. The slurry cleaning apparatus according to claim 12, further comprising an ultrasonic wave generator.

19. The slurry cleaning apparatus according to claim 12, further comprising a temperature controller.

20. The slurry cleaning apparatus according to claim 12, wherein the slurry is a slurry containing resin fine particles.

21. The slurry cleaning apparatus according to claim 12, wherein the slurry is a slurry containing toner matrix particles obtained by an emulsion polymerization aggregation method.

22. A stacking-type slurry cleaning apparatus, comprising a plurality of slurry cleaning apparatuses according to claim 12, wherein the slurry cleaning apparatuses are connected by stacking them on one another.

23. The stacking-type slurry cleaning apparatus according to claim 22, wherein the direction of flow of the cleaning water and the direction of flow of the slurry are opposite.

24. A slurry cleaning system, comprising a plurality of stacking-type slurry cleaning apparatuses according to claim 22, wherein the stacking-type slurry cleaning apparatuses are connected in series.

25. A slurry cleaning apparatus, comprising:
a cleaning chamber for contacting a slurry with cleaning water; and
flow rate controllers for controlling the flow rate of the slurry,
wherein:
the flow rate controllers are located respectively at a slurry inlet through which the slurry is fed to the cleaning chamber and at a slurry outlet through which the slurry is discharged from the cleaning chamber;
the slurry cleaning apparatus comprises a water supply cylinder in a substantially cylindrical shape, an inner cylinder member, and an outer cylinder member;
the inner cylinder member is disposed inside of the outer cylinder member;
the water supply cylinder is disposed inside of the inner cylinder member;
the space between the water supply cylinder and the inner cylinder member constitutes the cleaning chamber;
the slurry is fed to the cleaning chamber through the slurry inlet;
the cleaning water is fed into the cleaning chamber through a plurality of water spray pores formed in the outer periphery of the water supply cylinder;
the cleaning water fed into the cleaning chamber is brought into contact with the slurry in the cleaning chamber, and then subjected to filtration by a filtration member fitted to the inner side of the inner cylinder member; and
the cleaning water subjected to filtration by the filtration member is then stored in a filtrate storage chamber formed between the inner cylinder member and the outer cylinder member.

26. The slurry cleaning apparatus according to claim 25, wherein the filtration member is a filter cloth in a cylindrical shape.

27. The slurry cleaning apparatus according to claim 25, wherein a screw for transferring the slurry from the slurry inlet toward the slurry outlet is provided on the outer periphery of the water supply cylinder.

28. The slurry cleaning apparatus according to claim 27, which has a rotation driving device for rotating the water supply cylinder and the screw.

29. The slurry cleaning apparatus according to claim 25, further comprising a cleaning water feed device for feeding the cleaning water to the cleaning chamber, wherein the cleaning water is fed by the cleaning water feed device to the cleaning chamber at a constant flow rate.

30. The slurry cleaning apparatus according to claim 29, wherein the flow rate of the slurry and the slurry concentration in the cleaning chamber are controlled by the flow rate of the cleaning water fed by the cleaning water feed device.

31. The slurry cleaning apparatus according to claim 25, further comprising an ultrasonic wave generator.

32. The slurry cleaning apparatus according to claim 25, further comprising a temperature controller.

33. The slurry cleaning apparatus according to claim 25, wherein the slurry is a slurry containing resin fine particles.

34. The slurry cleaning apparatus according to claim 25, wherein the slurry is a slurry containing toner matrix particles obtained by an emulsion polymerization aggregation method.

35. A slurry cleaning system, comprising a plurality of slurry cleaning apparatuses according to claim 25, wherein the slurry cleaning apparatuses are connected in series.

36. A method for producing a toner for electrostatic image development, the method comprising cleaning a slurry with the slurry cleaning apparatus according to claim 1.

37. A method for producing a toner for electrostatic image development, the method comprising:
continuously feeding a slurry containing toner matrix particles to a cleaning apparatus;
continuously feeding cleaning water to the cleaning apparatus;
contacting the slurry with the cleaning water in the cleaning apparatus to clean the slurry;
continuously discharging the cleaned slurry from the cleaning apparatus;
subjecting to filtration the cleaning water after contacted with the slurry; and
continuously discharging the cleaning water after subjected to filtration from the cleaning apparatus,
wherein, in the cleaning apparatus, the direction of flow of the cleaning water is different from the direction of transfer of the slurry and has no countercurrent relationship with the direction of transfer of the slurry.
